(19) United States
(12) Patent Application Publication
(10) Pub. No.: US 2025/0203396 A1
(43) Pub. Date: Jun. 19, 2025

(54) TECHNIQUES TO FACILITATE QUALITY OF EXPERIENCE ENHANCEMENTS FOR HIGH MOBILITY SCENARIOS

(71) Applicant: QUALCOMM Incorporated, San Diego, CA (US)

(72) Inventors: Shankar KRISHNAN, Poway, CA (US); Jianhua LIU, Beijing (CN); Xipeng ZHU, San Diego, CA (US); Rajeev KUMAR, San Diego, CA (US)

(21) Appl. No.: 18/845,864

(22) PCT Filed: Apr. 29, 2022
(86) PCT No.: PCT/CN2022/090191

§ 371 Date: Sep. 10, 2024

(51) Int. Cl. H04W 24/02; H04W 24/08; H04W 24/10; H04W 28/24

(52) U.S. Cl. CPC H04W 24/02; H04W 24/08; H04W 24/10; H04W 28/24

(57) ABSTRACT

A network node obtains, from a core network component, a quality of experience (QoE) configuration associated with a high speed dedicated network (HSDN) indication and outputs the QoE configuration for a user equipment (UE) based on the UE being camped on an HSDN cell or based on a mobility condition of the UE. A UE receives, from a network node, a QoE configuration associated with an HSDN indication and collects QoE information based on at least one of an HSDN status of a cell or a mobility condition of the UE.

### TECHNICAL FIELD

The present disclosure relates generally to communication systems, and more particularly, to wireless communication systems utilizing mobility management.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. An apparatus may include a user equipment (UE). The example apparatus receives, from a network node, a quality of experience (QoE) configuration associated with a high speed dedicated network (HSDN) indication. The apparatus collects QoE information based on at least one of an HSDN status of a cell or a mobility condition of the UE.

In another aspect of the disclosure, a method, a computer-readable medium, and an apparatus are provided for wireless communication. An apparatus may include a network entity or network node, such as a base station. The example apparatus obtains, from a core network component, a QoE configuration associated with an HSDN indication. The apparatus outputs the QoE configuration for a UE based on the UE being camped on an HSDN cell or based on a mobility condition of the UE.

In another aspect of the disclosure, a method, a computer-readable medium, and an apparatus are provided for wireless communication. An apparatus may include a network entity or network node, such as a base station. The example apparatus obtains information as a target cell in a handover for a UE configured with a QoE configuration associated with an HSDN indication. The apparatus releases the QoE configuration for the UE.

In another aspect of the disclosure, a method, a computer-readable medium, and an apparatus are provided for wireless communication. An apparatus may include a network entity or network node, such as a base station. The example apparatus obtains, from a core network component, a QoE configuration associated with an HSDN indication. The apparatus outputs the QoE configuration to at least one UE, receives QoE information from the at least one UE, and reports the QoE information to the core network component for each UE of the at least one UE that includes an indication for at least one of an association with an HSDN cell or a high mobility condition of the at least one UE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an environment including UEs communicating with different network nodes.

FIG. 5 illustrates example scenarios for HSDN-capable UEs and HSDN non-capable UEs associated with high mobility and low mobility.

FIGS. 6A and 6B illustrates example aspects of UE mobility in connection with an HSDN cell.

FIG. 7 illustrates an example environment to facilitate providing QoE reports in high mobility scenarios as a UE moves between different mobility scenarios.

FIG. 8 illustrates an example communication flow including QoE configuration based on whether a UE is connected to an HSDN and/or in a high mobility state.

FIG. 9 illustrates an example communication flow including QoE configuration based on whether a UE is connected to an HSDN and/or in a high mobility state.

FIG. 10 illustrates an example communication flow including QoE configuration in connection with mobility of the UE.

FIG. 11 illustrates an example communication flow including QoE collection based on whether a UE is connected to an HSDN and/or in a high mobility state.

FIG. 12 illustrates an example communication flow including QoE reporting based on whether a UE is connected to an HSDN and/or in a high mobility state.

FIG. 13 illustrates an example communication flow including filtering of QoE reports at a network.

FIG. 14 illustrates an example environment to facilitate providing QoE reports in high mobility scenarios as a UE moves between different mobility scenarios.

FIGS. 15A and 15B are flowcharts of a method of wireless communication.

FIG. 16 is a diagram illustrating an example of a hardware implementation for an example apparatus and/or UE.

FIGS. 17A and 17B are flowcharts of a method of wireless communication.

FIG. 18 is a flowchart of a method of wireless communication.

FIG. 19 is a flowchart of a method of wireless communication.

FIG. 20 is a diagram illustrating an example of a hardware implementation for an example network entity.

### DETAILED DESCRIPTION

Devices in a wireless communication system may have different mobility states. The same device may have a different mobility state and different times. Examples of mobility states include a normal mobility state, a high mobility state (such as a UE traveling on a high speed train), and a medium mobility state. In some aspects, one or more high speed dedicated network (HSDN) may be provided for communication with devices in a high mobility state. A UE may be configured to provide QoE information to the network. The QoE of the UE may be affected by the type of cell, e.g., HSDN or non-HSDN, on which the UE performs QoE measurements and/or a mobility condition of the UE. Aspects presented herein enable improvements in the collection and/or reporting of QoE information and may enable more targeted information to be provided to a network. In some aspects, a network node may help to obtain the targeted QoE information by configuring UEs with a QoE configuration based on the UE camping on an HSDN cell and not configuring UEs camped on non-HSDN cells with the QoE configuration. This enables QoE measurement collection to be performed on HSDN cells and not on non-HSDN cells. In some aspects, the network node may provide the QoE configuration to UEs irrespective of the UE being camped on an HSDN cell or a non-HSDN cell. The UE may perform QoE measurements on HSDN cells and not on non-HSDN cells. In some aspects, the UE may provide QoE information to the network without differentiating between HSDN cells and non-HSDN cells, and a radio area network (RAN) may filter the QoE information reported by the UE to provide a network component, such as a measurement collection entity (MCE), with the QoE information for the HSDN cells, and not for the non-HSDN cells.

A QoE configuration may be “setup” or may be “released.” When the QoE configuration is setup, the QoE configuration is in an active state and the UE may perform QoE collection (e.g., measuring, calculating, and/or determining QoE information, which may also be referred to as “QoE metrics,” “QoE measurements,” or may any other suitable name) in accordance with the QoE configuration. When the QoE configuration is released, the QoE configuration is in a deactivated state and the UE may skip performing QoE collection of QoE information. For example, the network node may setup (e.g., activate) the QoE configuration when the UE camps on an HSDN cell and the network node may release (e.g., deactivate) the QoE configuration when the UE camps on a non-HSDN cell. In some examples, when a QoE configuration is setup, the QoE configuration remains active until the QoE configuration is released. For example, a first cell may setup a QoE configuration at a UE and the UE may continue performing QoE collection based on the QoE configuration as the UE moves to different cells until a second cell releases the QoE configuration. In some examples, when a network node is described as releasing a QoE configuration, the network node may transmit signaling to the UE to deactivate the QoE configuration at the UE. In some examples, when a UE is described as releasing a QoE configuration, the UE may stop performing QoE collection.

Information related to the mobility of the UE may be beneficial to the MCE as different mobilities may be associated with different levels of QoE. By having a UE or a RAN report QoE information that is specific to HSDN cells may assist the MCE in considering QoE provided to the UEs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

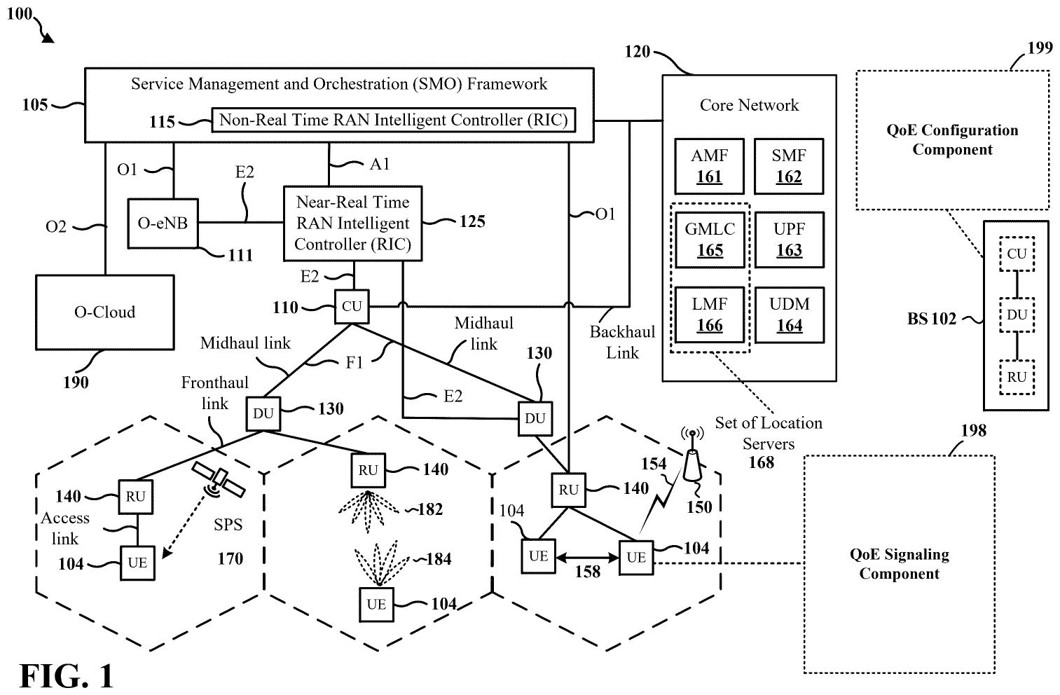

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC (e.g., a Non-RT RIC 115) associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUS (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a base station, such as the UE 104, may be configured to manage one or more aspects of wireless communication by facilitating QoE improvements for high mobility scenarios. For example, the UE 104 may include a QoE signaling component 198 configured to receive, from a network node, a QoE configuration associated with an HSDN indication and to collect QoE information based on at least one of an HSDN status of a cell or a mobility condition of the UE. A network node, such as a base station 102, or a component of a base station, such as a CU 110, DU 130, and/or RU 140, may include a QoE configuration component 199. In some aspects, the QoE configuration component 199 may be configured to obtain, from a core network component, a QoE configuration associated with an HSDN indication and to output the QoE configuration for a UE based on the UE being camped on an HSDN cell or based on a mobility condition of the UE. In some aspects, the QoE configuration component 199 may be configured to obtain information as a target cell in a handover for a UE configured with a QoE configuration associated with an HSDN indication and to release the QoE configuration for the UE. In some aspects, the QoE configuration component 199 may be configured to obtain, from a core network component, a QoE configuration associated with an HSDN indication, to output the QoE configuration to at least one UE, receive QoE information from the at least one UE, and report the QoE information to the core network component for each UE of the at least one UE that includes an indication for at least one of an association with an HSDN cell or a high mobility condition of the at least one UE. Although the following description provides examples directed to 5G NR, the concepts described herein may be applicable to other similar areas, such as LTE, LTE-A, CDMA, GSM, and/or other wireless technologies.

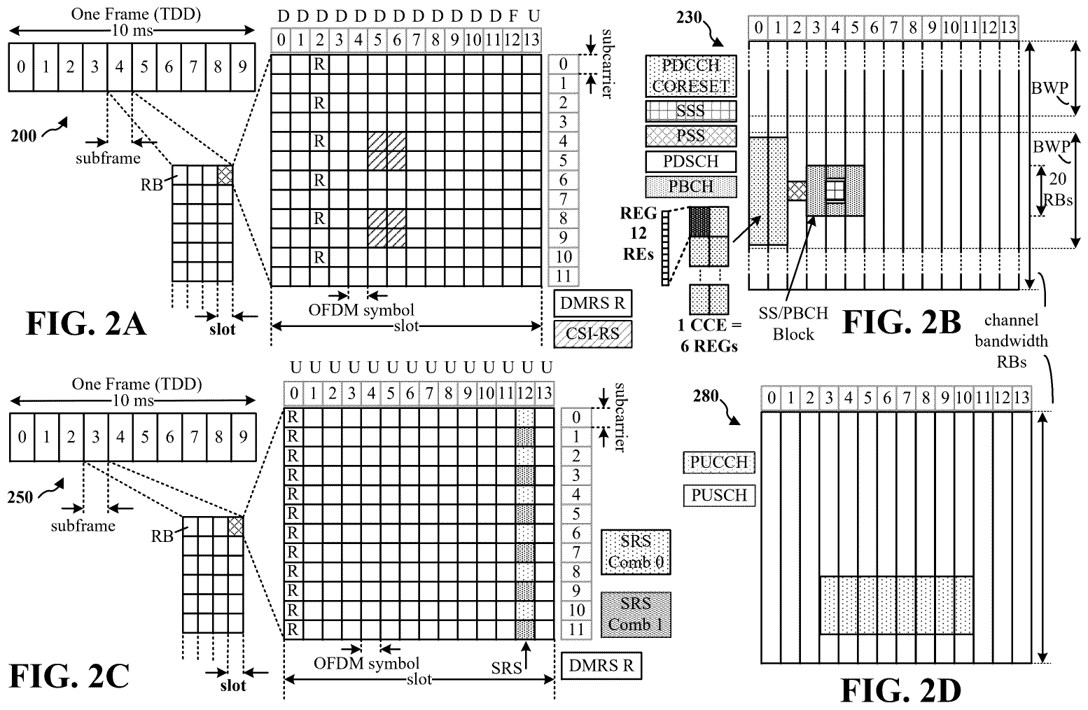

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

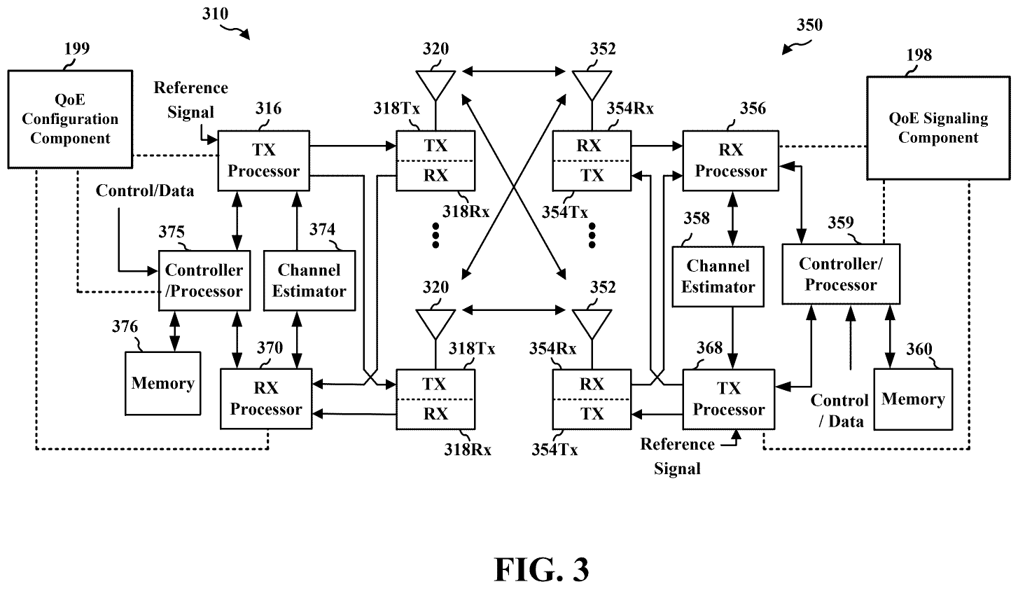

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the QoE signaling component 198 of FIG. 1.

At least one of the TX processor 316, the RX processor 370, and the controller/processor 375 may be configured to perform aspects in connection with the QoE configuration component 199 of FIG. 1.

A UE may collect (e.g., measure, calculate, and/or determine) QoE metrics for one or more cells serving the UE. The metrics may evaluate how a service facilitated by the UE is performing based on wireless communication with the cell. Examples of services include augmented reality (AR) services, mixed reality (MR) services, and multicast broadcast services (MBS). For example, a UE executing a VR application may collect metrics associated with the execution of the VR application. The example metrics may indicate whether the VR application is experiencing jitter, buffering, lag, etc. The metrics may then be evaluated to provide a Quality of Experience (QoE) related to the VR application.

Aspects disclosed herein provide techniques to provide QoE for high mobility scenarios. Examples of high mobility scenarios include UEs traveling at fast speeds, such as on a High Speed Trains (HST) or traveling on a highway. When a UE is in a high mobility scenario, the UE may enter and exit a cell provided by a base station at high speeds and, thus, may perform relatively frequent switches between base stations (e.g., cell reselection procedures). A High Speed Dedicated Network (HSDN) is a network configured to serve UEs in high mobility scenarios. As used herein, the term “HSDN” may be refer to a high-speed dedicated network and/or to a non-terrestrial network (NTN) in which a UE may connect to a highly-mobile satellite for a duration. In some examples in which the UE is connected to an NTN, the UE may be connected to the satellite for a short duration, but the communication may have high Doppler.

The HSDN may be configured with one or more aspects to provide coverage to a UE in a high mobility scenario. For example, a cell serving an HSDN (e.g., an HSDN cell) may be associated with a higher priority than other cells for cell reselection for UEs in a high-mobility state and that have the capability to connect to the HSDN (e.g., an HSDN-capable UE).

In some aspects, an HSDN-capable UE may or may not be configured to perform cell reselection while operating in an idle state (“RRC_IDLE”) or in an inactive state (“RRC_INACTIVE”).

A cell may provide a 1-bit indication in a system information block (SIB) message (e.g., a “SIB1” message) to indicate that the cell is an HSDN cell. An HSDN cell may also be referred to as an “NR HSDN cell.” The HSDN cell may also provide information relating to HSDN neighboring cells via corresponding SIBs for intra-frequency reselection, inter-frequency reselection, and/or inter-RAT reselection. The HSDN cell may provide the information relating to HSDN neighboring cells in an HSDN neighboring cell list with physical cell identities (PCIs).

An HSDN-capable UE may perform cell reselections based on its mobility state. For example, a UE that is in a high-mobility state may consider HSDN cells to be the highest priority, such as higher than any other network configured priorities. A UE that is not in a high-mobility state (e.g., is in the normal-mobility state or the medium-mobility state) may consider HSDN cells to be the lowest priority, such as lower than network configured priorities.

The HSDN cell may provide one or more mobility state parameters that enable a UE to estimate a mobility state of the UE, e.g., from a set of possible mobility states. Example mobility states of a UE include a “normal-mobility state,” a “high-mobility state,” and a “medium-mobility state.” The serving cell may broadcast one or more of the mobility state parameters via SIBs, such as a “SIB2” message. Examples of mobility state parameters include a duration parameter, a medium-mobility state threshold, a high-mobility state threshold, an additional period parameter, and a cell count. The duration parameter, which may be referred to as a “TCRmax” parameter or by any other name, indicates a duration for evaluating an allowed amount of cell reselections. The medium-mobility state threshold, which may be referred to as an “NCR_M” parameter or by any other name, indicates a maximum number of cell reselections to enter the medium-mobility state. The high-mobility state threshold, which may be referred to as an “NCR_H” parameter or by any other name, indicates a maximum number of cell reselections to enter the high-mobility state. The additional period parameter, which may be referred to as a “TCRmaxHyst” parameter or by any other name, indicates an additional time period before the UE can enter the normal-mobility state. The cell count parameter, which may be referred to as a “cellEquivalentSize” parameter or by any other name, indicates a number of cell count associated with the serving HSDN cell.

To determine its mobility state, the UE may default to the normal-mobility state and determine a number of cell reselections. In examples in which the UE is configured with the cellEquivalentSize parameter, the UE may use the number indicated by the cellEquivalentSize parameter as the number of cell reselections. In examples in which the UE is not configured with the cellEquivalentSize parameter, the UE may count the number of cell reselections performed during a period based on the TCRmax parameter. The UE may determine it is in a medium-mobility state when the number of cell reselections exceeds the medium-mobility state threshold, as indicated by the NCR_M parameter, and does not exceed the high-mobility state threshold, as indicated by the NCR_H parameter. The UE may determine it is in a high-mobility state when the number of cell reselections exceeds the high-mobility state threshold, as indicated by the NCR_H parameter.

After determining its mobility state, the UE may enter the corresponding mobility state. For example, if the criteria for the high-mobility state is detected, then the UE may enter the high-mobility state, e.g., by adjusting behavior such as cell selection parameters or prioritization based on the mobility state determined for the UE. If the criteria for the high-mobility state is not detected and the criteria for the medium-mobility state is detected, then the UE may enter the medium-mobility state. If the criteria for either the high-mobility state or the medium-mobility state is not detected during an additional period, as indicated by the TCRmaxHyst parameter, then the UE may enter the normal-mobility state. In some examples, when the UE is in the high-mobility state or the medium-mobility state, the UE may apply one or more speed dependent scaling rules to measurements perform by the UE. For example, based on the mobility-state of the UE, the UE may apply a speed dependent scaling factor to an event timing parameter. Examples of speed dependent scaling factors may include a scaling factor for Qhyst (e.g., including a scaling factor for a high mobility state and a scaling factor for a medium mobility state), one or more reselection time scaling factors for one or more RATs (e.g., a scaling factor for a high mobility state and a scaling factor for a medium mobility state for one or more of NR such as “Treselection NR”, EUTRA such as “Treselection EUTRA”, UTRA such as “TreselectionUTRA”, etc.). The event timing parameter, which may be referred to as a “timeToTrigger parameter” or by any other name, may indicate a time during which, when specific criteria for an event are met, a measurement report may be triggered.

As an example of a scaling factor application, the UE may not apply scaling if the UE is not in a medium or high mobility state. If a high or medium mobility state is detected for the UE, the UE may add the corresponding scaling factor to Qhyst if sent on system information. For E-UTRAN, UTRAN, GERAN, CDMA2000 HRPD, CDMA2000 1×RTT, or NR cells the UE may multiply TreselectionRAT by the corresponding speed dependent, and RAT dependent, scaling factor if sent on system information. If scaling is applied, the UE may round up the result after the scaling to the nearest second.

A network may provide a UE with information about HSDN cells. As an example, a system information block may carry information indicating whether the cell is an HSDN cell, a cell equivalent size (e.g., a number of cell count used for mobility state estimation for the cell), cell reselection information, intra-frequency neighbor HSDN cell information (e.g., a list of intra-frequency neighboring HSDN cells), an HSDN indication that indicates whether there are deployed HSDN cells or not on the downlink frequency indicated by a corresponding downlink carrier frequency parameter, an inter-frequency neighbor HSDN information (e.g., a list of inter-frequency neighboring HSDN cells).

In some aspects if the received measurement configuration (e.g., which may be referred to as “measConfig”) includes speed state parameters (which may be referred to as “speedStatePars”), the parameter speedStatePars within a measurement configuration (which may be referred to as “VarMeasConfig”) may be set to the received value of speedStatePars. The UE may adjust the value of the time ToTrigger parameter configured by the E-UTRAN depending on the UE speed. The UE may apply 3 different levels, which are selected between. The UE may perform a mobility state detection using the mobility state detection with the modifications: counting handovers instead of cell reselections; applying the parameter applicable for an RRC connected UE as included in speedStatePars within VarMeasConfig. If a high mobility state is detected, the UE may use the timeToTrigger value multiplied by sf-High within VarMeasConfig. If a medium mobility state is detected, the UE may use the time ToTrigger value multiplied by sf-Medium within VarMeasConfig. Otherwise, the UE may not apply scaling.

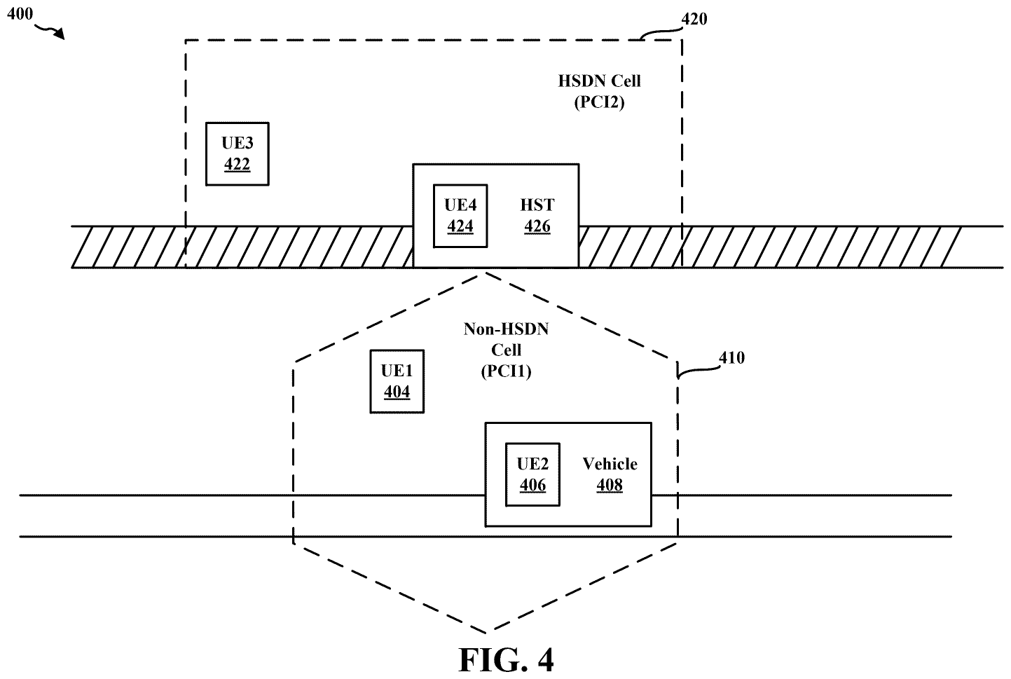

FIG. 4 illustrates an environment 400 including UEs communicating with different network nodes, as presented herein. In the illustrated example of FIG. 4, the environment 400 includes a non-HSDN cell 410 and an HSDN cell 420. The cells may be associated with physical cell identifiers (PCI). For example, the non-HSDN cell 410 may be associated with a first PCI (“PCI1”), and the HSDN cell 420 may be associated with a second PCI (“PCI2”). Although not shown in the example of FIG. 4, the non-HDSD cell may be served by a non-HSDN network node, and the HSDN cell may be served by an HSDN network node. Although the non-HSDN cell is illustrated as having a hexagonal shape and the HSDN cell is illustrated as having a rectangular shape, in other examples, the coverage area associated with the non-HSDN cell 410 and/or the HSDN cell 420 may be associated with a different shape.

As shown in FIG. 4, the non-HSDN cell 410 includes a first UE 404 (“UE1”), a second UE 406 (“UE2”), and a vehicle 408. The first UE 404 and the second UE 406 may be camping on the non-HSDN cell 410. In the example of FIG. 4, the first UE 404 is located outside of the vehicle 408, and the second UE 406 is located in the vehicle 408. The vehicle 408 may be stationary, may be moving at a low speed, or may be moving at a high speed. Accordingly, the mobility state associated with the second UE 406 may be based on whether the vehicle 408 is stationary and the speed at which the vehicle 408 is traveling.

The HSDN cell 420 of FIG. 4 includes a third UE 422 (“UE3”), a fourth UE 424 (“UE4”), and an HST 426. As shown in FIG. 4, the third UE 422 is located outside of the HST 426, and the fourth UE 424 is in the HST 426. The HST 426 may be in a moving state or in a stationary state. Accordingly, the mobility state associated with the fourth UE 424 may be based on the whether the HST 426 is in the moving state or the stationary state.

In the example of FIG. 4, each of the UEs may be associated with high mobility or low mobility. As used herein, the term “high mobility” may refer to a scenario in which a UE satisfies the criteria associated with being in a high-mobility state (e.g., the number of cell reselections exceeds the high-mobility state threshold, as indicated by the NCR_H parameter). The term “high mobility” may also refer to scenarios in which a UE is traveling with relatively low mobility, but on a high-speed vehicle. For example, the vehicle 408 may be traveling at a high speed that is relatively slower than the HST 426. In such scenarios, the second UE 406 may be stationary, but may be associated with high mobility or low mobility based on the speed of the vehicle 408. In some examples, the vehicle 408 may be deployed as a mobile IAB node.

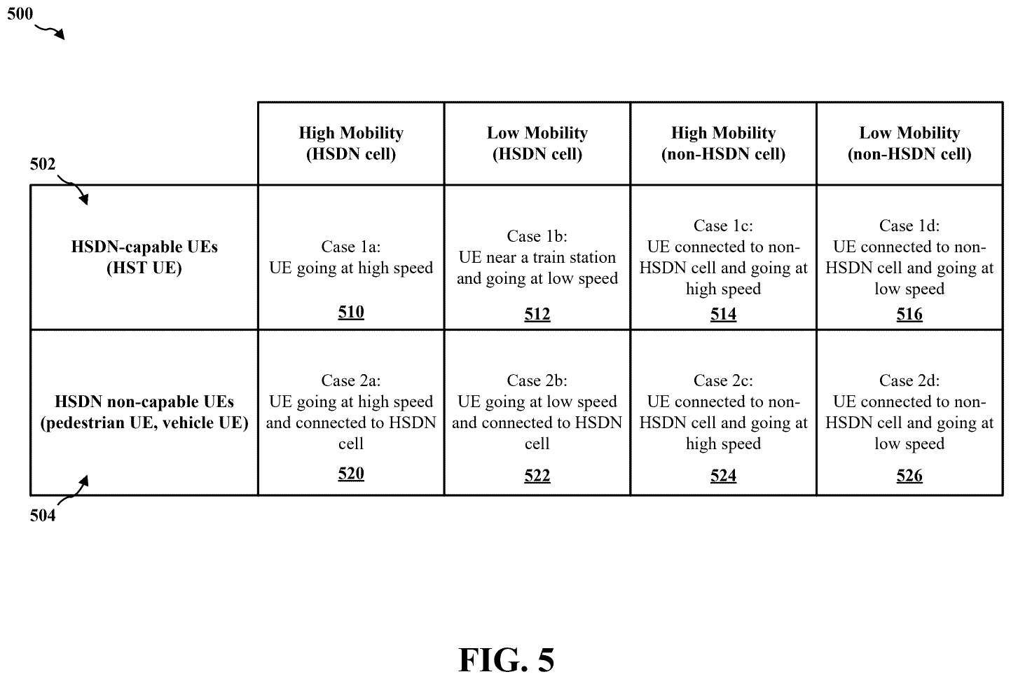

FIG. 5 depicts an example table 500 illustrating example scenarios for HSDN-capable UEs and HSDN non-capable UEs associated with high mobility and low mobility, as presented herein. Aspects of FIG. 5 are described in connection with the example environment 400 of FIG. 4. In a first set of scenarios, the UE may be an HSDN-capable UE 502, and the UE may be an HSDN non-capable UE 504 in a second set of scenarios. Examples of an HSDN-capable UE 502 may include a UE with the ability to communicate via an HSDN, such as a UE configured for communicating while on an HST. Examples of an HSDN non-capable UE 504 may include a UE without the ability to communicate via an HSDN, such as a pedestrian UE or a vehicle UE.

As shown in FIG. 5, the HSDN-capable UE 502 and the HSDN non-capable UE 504 may be in different scenarios based on whether the respective UE is associated with high mobility or low mobility, and whether the respective UE is connected to an HSDN cell or a non-HSDN cell (sometimes referred to herein as a “legacy network”). For example, in a first scenario 510 (“Case 1a”), the HSDN-capable UE 502 may be connected to an HSDN cell and traveling at a high speed, such as the example fourth UE 424 connected to the HSDN cell 420 of FIG. 4. In a second scenario 512 (“Case 1b”), the HSDN-capable UE 502 may be connected to an HSDN cell and traveling at a low speed, such as the example third UE 422 connected to the HSDN cell 420 of FIG. 4. In a third scenario 514 (“Case 1c”), the HSDN-capable UE 502 may be connected to a non-HSDN cell and traveling at a high speed, such as the example second UE 406 connected to the non-HSDN cell 410 of FIG. 4. In a fourth scenario 516 (“Case 1d”), the HSDN-capable UE 502 may be connected to a non-HSDN cell and traveling at a low speed, such as the example first UE 404 connected to the non-HSDN cell 410 of FIG. 4.

In a fifth scenario 520 (“Case 2a”), the HSDN non-capable UE 504 may be connected to an HSDN cell and traveling at a high speed, such as the example fourth UE 424 connected to the HSDN cell 420 of FIG. 4. In a sixth scenario 522 (“Case 2b”), the HSDN non-capable UE 504 may be connected to an HSDN cell and traveling at a low speed, such as the example third UE 422 connected to the HSDN cell 420 of FIG. 4. In a seventh scenario 524 (“Case 2c”), the HSDN non-capable UE 504 may be connected to a non-HSDN cell and traveling at a high speed, such as the example second UE 406 connected to the non-HSDN cell 410 of FIG. 4. In an eighth scenario 526 (“Case 2d”), the HSDN non-capable UE 504 may be connected to a non-HSDN cell and traveling at a low speed, such as the example first UE 404 connected to the non-HSDN cell 410 of FIG. 4.

Aspects disclosed herein provide techniques to provide QoE for high mobility scenarios. In some examples, the high mobility scenarios may be associated with a UE connected to an HSDN cell, such as the example first scenario 510 or the example fifth scenario 520. In some examples, the high mobility scenarios may be associated with a UE connected to a non-HSDN cell, such as the example third scenario 514 or the example seventh scenario 524. However, the aspects disclosed herein may also improve QoE reporting in scenarios in which the UE is connected to an HSDN cell and associated with low mobility (e.g., the example second scenario 512 or the example sixth scenario 522), or the UE is connected to a non-HSDN cell and associated with low mobility (e.g., the example fourth scenario 516 or the example eighth scenario 526).

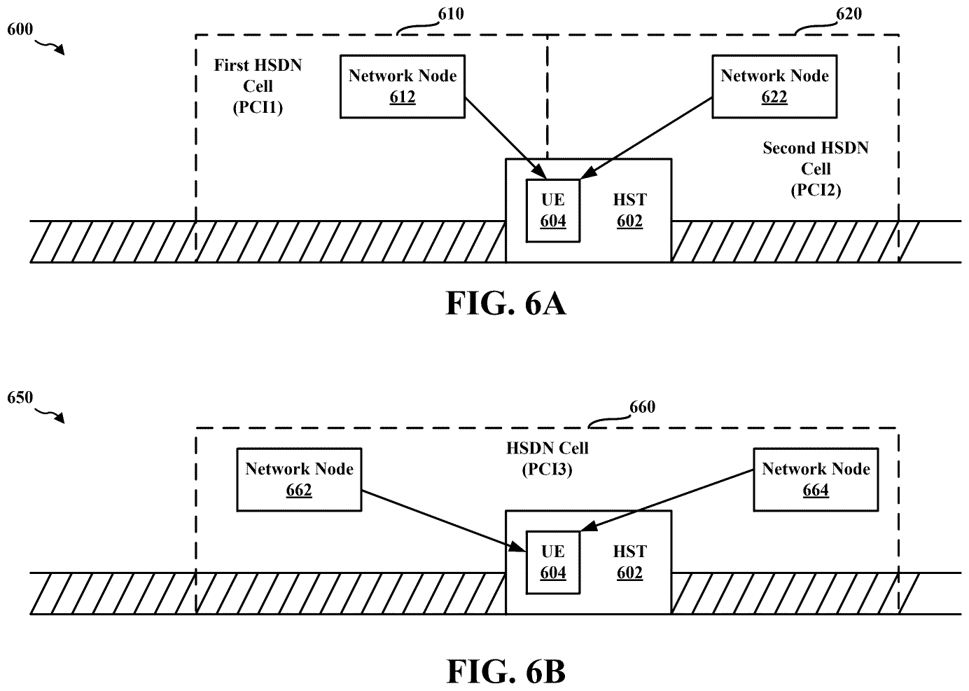

As described above, an HSDN may be configured with one or more aspects to provide coverage to a UE in high mobility scenarios. For example, the HSDN may provide aspects to improve handover between network nodes when in a high mobility scenario. FIG. 6A and FIG. 6B illustrate example deployments in which a UE 604 may perform a handover procedure in an HSDN. FIG. 6A illustrates an example environment 600 in which the UE 604 may perform a handover procedure between different HSDN cells, as presented herein. In the example of FIG. 6A, a first network node 612 may provide coverage to an area associated with a first HSDN cell 610 (“PCI1”), and a second network node 622 may provide coverage to an area associated with a second HSDN cell 620 (“PCI2”).

As shown in FIG. 6A, the UE 604 may be traveling on an HST 602 and travel from the first HSDN cell 610 to the second HSDN cell 620. In such scenarios, the UE 604 may perform a handover procedure with the first network node 612 and the second network node 622 when traveling from the first HSDN cell 610 to the second HSDN cell 620.

FIG. 6B illustrates an example environment 650 in which the UE 604 may perform a handover procedure between different network nodes of an HSDN cell, as presented herein. In the example of FIG. 6B, an HSDN cell 660 (“PCI3”) may be a single frequency network (SFN) in which two or more network nodes provide coverage to the HSDN cell 660 and simultaneously transmit the same signal on the same frequency. For example, the HSDN cell 660 includes a first network node 662 and a second network node 664. Aspects of the first network node 662 and the second network node 664 may be implemented by respective remote radio heads (RRH) or an RU. In the HSDN cell 660, the UE 604 may receive the same signal from different network nodes. For example, the first network node 662 and the second network node 664 may be configured to transmit the same signal that the UE 604 may receive. In such scenarios, the UE 604 may perform a handover procedure with the first network node 662 and the second network node 664 when traveling within the HSDN cell 660.

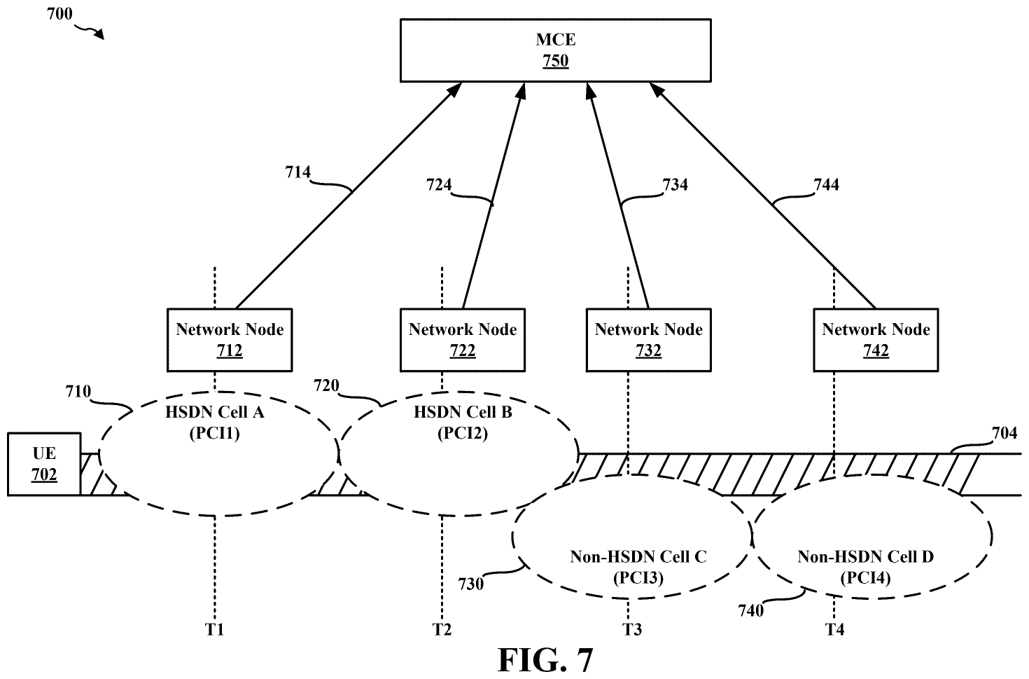

FIG. 7 illustrates an example environment 700 to facilitate providing QoE reports in high mobility scenarios as a UE 702 moves between different mobility scenarios, as presented herein. In the example of FIG. 7, the UE 702 may be an HSDN-capable UE, such as the HSDN-capable UE 502 of FIG. 5. The UE 702 may also be located on a vehicle capable of high mobility, such as an HST or a vehicle traveling on a highway.

As shown in FIG. 7, the environment 700 provides coverage to UEs traveling on a path 704, which may be a railway track or a highway. For example, at time T1, the UE 702 may be connected to a first network node 712 that provides coverage to a first cell 710 (“PCI1”), at time T2, the UE 702 may be connected to a second network node 722 that provides coverage to a second cell 720 (“PCI2”), at time T3, the UE 702 may be connected to a third network node 732 that provides coverage to a third cell 730 (“PCI3”), and at time T4, the UE 702 may be connected to a fourth network node 742 that provides coverage to a fourth cell 740 (“PCI4”). As shown in FIG. 7, the first cell 710 and the second cell 720 are HSDN cells, and the third cell 730 and the fourth cell 740 are non-HSDN cells.

In the example of FIG. 7, the UE 702 may be associated with different mobilities while traveling from the first cell 710 to the fourth cell 740. For example, at time T1, the UE 702 may be traveling at full speed and associated with high mobility while connected to an HSDN cell, as described in connection with the first scenario 510 of FIG. 5. At time T2, the UE 702 may be traveling at a low speed and associated with low mobility while connected to an HSDN cell, as described in connection with the second scenario 512 of FIG. 5. At time T3, the UE 702 may be traveling at full speed and associated with high mobility while connected to a non-HSDN cell, as described in connection with the third scenario 514 of FIG. 5. At time T4, the UE 702 may be traveling at low speed and associated with low mobility while connected to a non-HSDN cell, as described in connection with the fourth scenario 516 of FIG. 5.

In the example of FIG. 7, the UE 702 provides QoE measurement reports that are received by a measurement collection entity (MCE) (e.g., an MCE 750). The MCE 750 may include a network entity configured to receive QoE measurement reports. The QoE measurement reports, sometimes referred to as “QoE reports,” may include application layer measurements from the UE 702 associated with different services, such as streaming services, AR services, MR services, and/or MBS services.

The UE 702 may provide different QoE measurement reports as the UE 702 travels from the first cell 710 to the fourth cell 740. For example, the UE 702 may provide a first QoE measurement report 714 while connected to the first cell 710 at the time T1, may provide a second QoE measurement report 724 while connected to the second cell 720 at the time T2, may provide a third QoE measurement report 734 while connected to the third cell 730 at the time T3, and may provide a fourth QoE measurement report 744 while connected to the fourth cell 740 at the time T4. The respective QoE measurement reports may include QoE metrics measured by the UE 702 at the respective times. Examples of QoE metrics may include a buffer level, a playout delay for media startup, etc.

However, while the QoE measurement reports may provide information collected at the application layer, the QoE measurement reports may not provide information related to the mobility of the UE 702. For example, the QoE measurement reports may not include information indicating whether the UE 702 is connected to an HSDN network or a non-HSDN network. The QoE measurements may additionally, or alternatively, not include information indicating whether the UE 702 is associated with high mobility or low mobility. Information related to the mobility of the UE 702 may be beneficial to the MCE 750 as different mobilities may be associated with different levels of QoE.

Aspects disclosed herein provide techniques for improving QoE measurement reports in high mobility scenarios. The UE may be configured to collect measurements and to provide QoE measurement reports based on a QoE configuration. The QoE configuration may be configured so that the QoE measurement report provides an indication of whether the measurements are associated with a UE connected to an HSDN cell or to a UE under high mobility. Based on the information provided in the QoE measurement report, the MCE may process the received QoE measurement reports accordingly. The aspects may enable the UE and/or a RAN to filter collection or reporting of the QoE information in order to provide QoE information that is for HSDN cells and not for non-HSDN cells.

In some examples, the network may provide a QoE configuration to the UE when the UE is camped on an HSDN cell or is under high mobility, such as the first scenario 510, the second scenario 512, and/or the third scenario 514 of FIG. 5. The network may not configure the QoE configuration for a UE that is camped on a non-HSDN cell. In such network-based aspects, the UE may be configured to collect measurements and to provide QoE measurement reports while connected to an HSDN cell or under high mobility and, thus, the MCE may process the received QoE measurement reports accordingly.

In some examples, the network may provide a QoE configuration to the UE regardless of whether the UE is camped on an HSDN cell or a non-HSDN cell, and regardless of whether the UE is under high mobility or low mobility, such as the first scenario 510, the second scenario 512, the third scenario 514, and/or the fourth scenario 516 of FIG. 5. However, the QoE configuration may configure the UE to collect measurements while the UE is connected to an HSDN cell or under high mobility. In such UE-based aspects, the UE may be configured to provide the QoE measurement reports while connected to an HSDN cell or a non-HSDN cell.

In some examples, the network may provide a QoE configuration to the UE regardless of whether the UE is camped on an HSDN cell or a non-HSDN cell, and regardless of whether the UE is under high mobility or low mobility, such as the first scenario 510, the second scenario 512, the third scenario 514, and/or the fourth scenario 516 of FIG. 5. Additionally, the UE may be configured to collect measurements and to provide QoE measurement reports regardless of the type of cell that the UE is camping on and the mobility of the UE. However, the network may perform filtering of the QoE measurement reports based on indications included in the QoE measurement reports. For example, a QoE measurement report received at the MCE may include an HSDN indication indicating whether the UE is connected to an HSDN cell or a non-HSDN cell. The QoE measurement report may also include a mobility state indication indicating the mobility state of the UE. In some examples, the UE may include the HSDN indication and/or the mobility state indication when generating the QoE measurement report. In some examples, the network may append the HSDN indication and/or the mobility state indication when forwarding the QoE report from the UE to the MCE. In such post-processing-based aspects, the MCE may filter the received QoE reports based on the HSDN indication and the mobility state indication.

In a post-processing based solution, the QoE measurement report received at an MCE may be configured, e.g., via the QoE configuration, to include an HSDN indicator that indicates whether the UE is connected to an HSDN cell or a non-HSDN cell. The HSDN indicator may be 1-bit indicator in which a first value indicates that the UE is connected to an HSDN cell and a second value indicates that the UE is connected to a non-HSDN cell. In some examples, the QoE measurement report may additionally, or alternatively, be configured to include a mobility state indicator that indicates a mobility state of the UE.

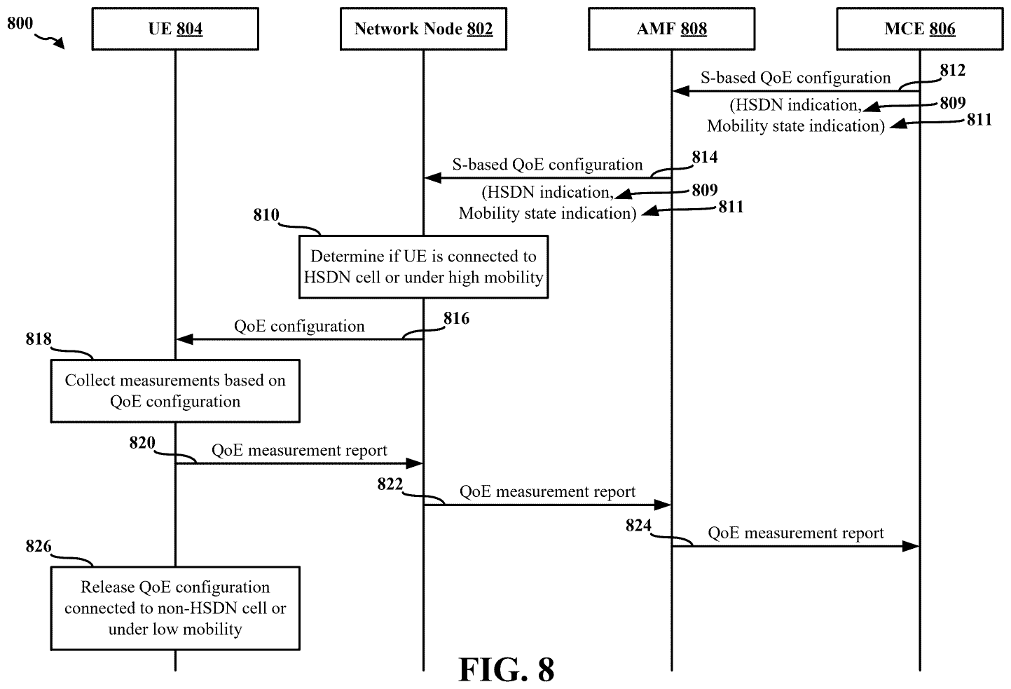

FIG. 8 illustrates an example communication flow 800 involving a UE 804, a network node 802, and core network components such as an AMF 808 and an MCE 806 in which a network node may filter the QoE configuration for UEs camped on an HSDN cell or in a high mobility state. The network node 802 may correspond to a RAN or a component of a RAN. The network node 802 may correspond to a base station, such as the base station 102 or the base station 310, or a component of a base station such as the CU 110, DU 130, or RU 140.

As illustrated, the MCE may send a signaling based (s-based) QoE configuration (e.g., an s-based QoE configuration 812) to the AMF 808 with an HSDN indication 809 and/or a mobility indication 811. The HSDN indication indicates that the QoE configuration is for QoE associated with HSDN cells and/or with a mobility state of a UE. At 810, the network node 802 determines if the UE 804 is connected to an HSDN cell or is in a high mobility state. As shown in FIG. 8, the AMF 808 transmits an s-based QoE configuration 814 to the network node 802 along with the HSDN indication 809 and/or mobility indication 811. In some examples, the AMF 808 may forward the s-based QoE configuration 812 as the s-based QoE configuration 814 to the network node 802. For example, the network node 802 may obtain (e.g., receive) the s-based QoE configuration 814 from the AMF 808. The network node 802 then configures QoE configuration to a UE 804 based on the UE being camped on an HSDN cell or if UE 804 is under a high mobility condition, e.g., as determined at 810. For example, the network node 802 may not configure the QoE configuration for the UE 804 if the UE 804 was camped on a non-HSDN cell or was not under the high mobility condition. As shown in FIG. 8, the network node 802 outputs (e.g., transmits or communicates) a QoE configuration 816 that is received by the UE 804. The UE 804 collects QoE measurements, at 818, based on the QoE configuration 816. For example, the UE 804 may measure QoE information, calculate QoE information, and/or determine QoE information based on the QoE configuration 816. The UE 804 transmits a QoE measurement report 820 to the network node 802 with the collected QoE measurements. The network node 802 provides a QoE measurement report 822 to the AMF 808. The AMF 808 provides a QoE measurement report 824 to the MCE 806. As the MCE 806 provided the QoE configuration with the HSDN indication 809 and/or the mobility indication 811 (e.g., the s-based QoE configuration 812), the MCE 806 may be aware that the QoE measurement report based on the s-based QoE configuration 812 is for HSDNs and/or for UEs in a high mobility state.

As illustrated at 826, the UE 804 may release the QoE configuration if the UE 804 connects to a non-HSDN cell and/or if the UE's mobility state changes to a lower mobility state. For example, the UE 804 may release the QoE configuration 816 received from the network node 802.

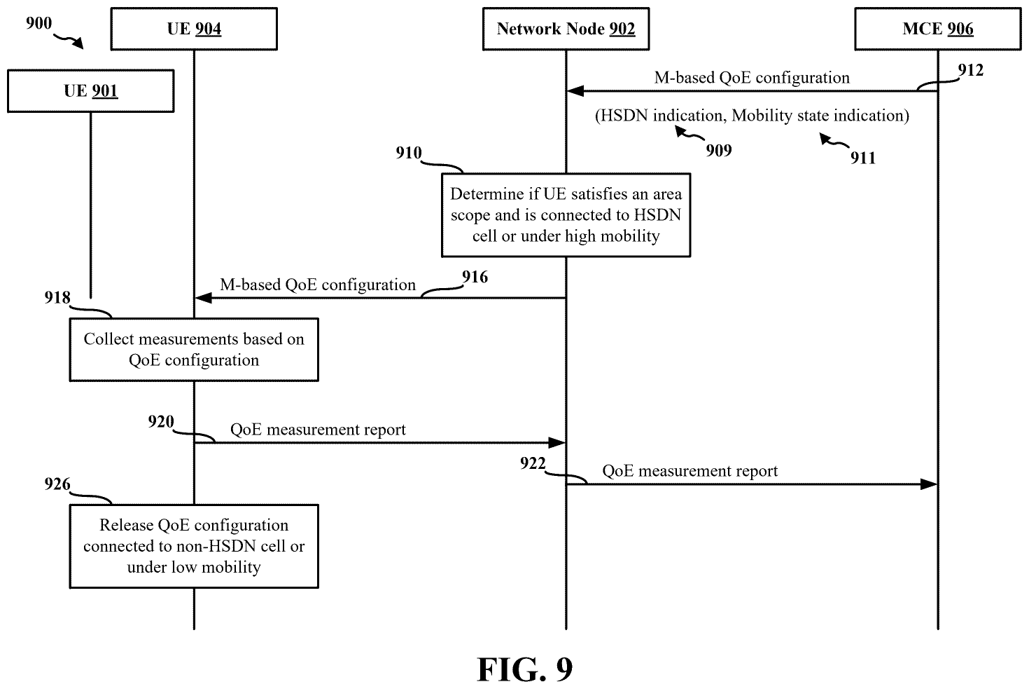

FIG. 9 illustrates an example communication flow 900 involving a UE 904, a network node 902, and a core network component such as an MCE 906 in which a network node may filter the QoE configuration for UEs camped on an HSDN cell or in a high mobility state. The network node 902 may correspond to a RAN or a component of a RAN. The network node 902 may correspond to a base station, such as the base station 102 or the base station 310, or a component of a base station such as the CU 110, DU 130, or RU 140.

As illustrated, the MCE 906 may output (e.g., transmit or communicate) a QoE configuration 912 and the network node 902 may obtain (e.g., receive) the QoE configuration 912. The QoE configuration 912 may include an HSDN indication 909 and/or a mobility indication 911. In contrast to the s-based QoE configuration 812 in FIG. 8, the QoE configuration 912 in FIG. 9 may be a management based (m-based) QoE configuration. The HSDN indication 909 and/or the mobility indication 911 indicates that the QoE configuration 912 is for QoE associated with HSDN cells and/or with a mobility state of a UE. At 910, the network node 902 determines if the UE 904 is connected to an HSDN cell or is in a high mobility state. The network node 902 then configures QoE configuration to one or more UE, e.g., including the UE 904, based on the UE 904 being camped on an HSDN cell or if UE 904 is under a high mobility condition, e.g., as determined at 910. For example, the network node 902 may not configure the QoE configuration for a UE 901 that is either camped on a non-HSDN cell or is not under the high mobility condition. The network node 902 may select only those UEs for an m-based QoE configuration that satisfy an area condition and if HSDN Indication=TRUE and/or if mobility state=high. If a UE is currently not in an HSDN cell or if the UE is not under a high mobility condition when the network node 902 receives the QoE configuration 912, the network node 902 may store the QoE configuration 912 and forward it to a target RAN upon mobility of the UE.

As shown in FIG. 9, the network node 902 outputs (e.g., transmits or communicates) an m-based QoE configuration 916 that is received by the UE 904. The UE 904 collects QoE measurements, at 918, based on the m-based QoE configuration 916. For example, the UE 904 may measure QoE information, calculate QoE information, and/or determine QoE information based on the m-based QoE configuration 916. The UE 904 transmits a QoE measurement report 920 to the network node 902 with the collected QoE measurements. The network node provides the QoE measurement report to the MCE, at 922. As the MCE provided the QoE configuration with the HSDN indication 909 and/or the mobility indication 911, the MCE may be aware that the QoE measurement report based on the QoE configuration 912 is for HSDNs and/or for UEs in a high mobility state.

As illustrated at 926, the UE 904 may release a QoE configuration if the UE 904 connects to a non-HSDN cell and/or if the UE's mobility state changes to a lower mobility state. For example, the UE 904 may release the QoE measurement report 920 received from the network node 902.

In FIG. 8 and FIG. 9, the QoE measurement collection is done on HSDN cells or cells with high mobility, e.g., and not on non-HSDN cells or cells with lower mobility. The QoE measurement report 920 will be sent from HSDN cells or when UE is under high mobility, as QoE configuration is released otherwise.

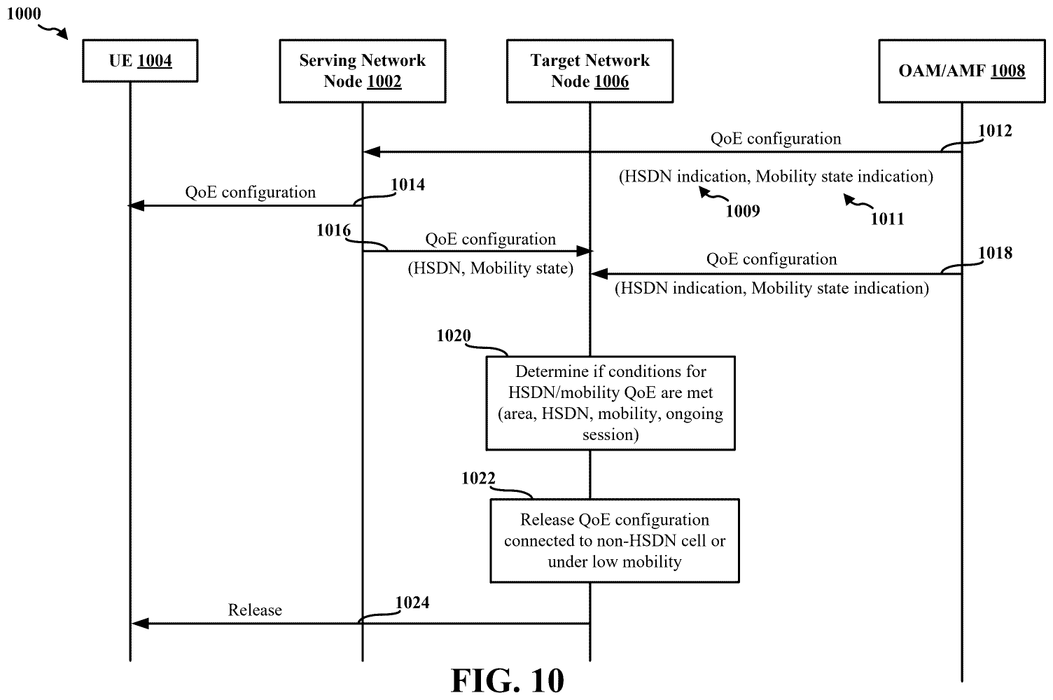

FIG. 10 illustrates an example communication flow 1000 involving a serving network node 1002 (which may also be referred to as a source network node) serving a UE 1004, and a target network node 1006, and an operations administration and maintenance (OAM) or AMF (e.g., an OAM/AMF 1008). The serving network node 1002 and/or the target network node 1006 may each correspond to a RAN or a component of a RAN. The serving network node 1002 and/or the target network node 1006 may correspond to a base station, such as the base station 102 or the base station 310, or a component of a base station such as the CU 110, DU 130, or RU 140.

In response to mobility of the UE 1004, and/or a change in a mobility state of the UE 1004, the network may initiate a handover of the UE from the serving network node 1002 to the target network node 1006. The serving network node 1002 may correspond to the network node 802 or the network node 902 from FIG. 8 or FIG. 9, respectively, and may have previously provided the UE with a QoE configuration from an MCE, as described in connection with FIG. 8 or FIG. 9. For example, the serving network node 1002 may have provided the UE 1004 with a QoE configuration 1014 for HSDN or high mobility conditions based on a QoE configuration 1012 obtained (e.g., received) from the OAM/AMF 1008 or the MCE with the HSDN indication 1009 and/or the mobility state indication 1011 indicating that the QoE configuration is for measurements of an HSDN or in a high mobility state. As illustrated in FIG. 10, an HSDN indication and/or a mobility indication may be propagated to the target network node 1006 during a handover procedure to the target network node 1006, e.g., via a QoE configuration 1016 from the serving network node 1002 or a QoE configuration 1018 from the OAM/AMF 1008. As an example, the indication may be provided to the target network node 1006 during an Xn handover, an NG Handover, or during an Xn retrieval of a UE Context.

The target network node 1006 may release the QoE configuration based on one or more criteria or conditions. As an example, at 1020, the target network node 1006 may determine whether the conditions for the QoE configuration are met. As an example, the target network node 1006 may release the QoE configuration for the UE, at 1022, if the target network node 1006 is outside the corresponding geographic area for the QoE configuration. The target network node 1006 may release the QoE configuration for the UE, at 1022, if the target network node provides a non-HSDN cell to which the UE is being handed over. The target network node 1006 may release the QoE configuration for the UE, at 1022, if the UE is under a lower mobility condition than is associated with the QoE configuration. In some aspects, the target network node 1006 may release the QoE configuration for the UE, at 1022, if there are no ongoing sessions for the QoE configuration. FIG. 10 illustrates that the target network node 1006 may indicate the release to the UE 1004 at 1024.

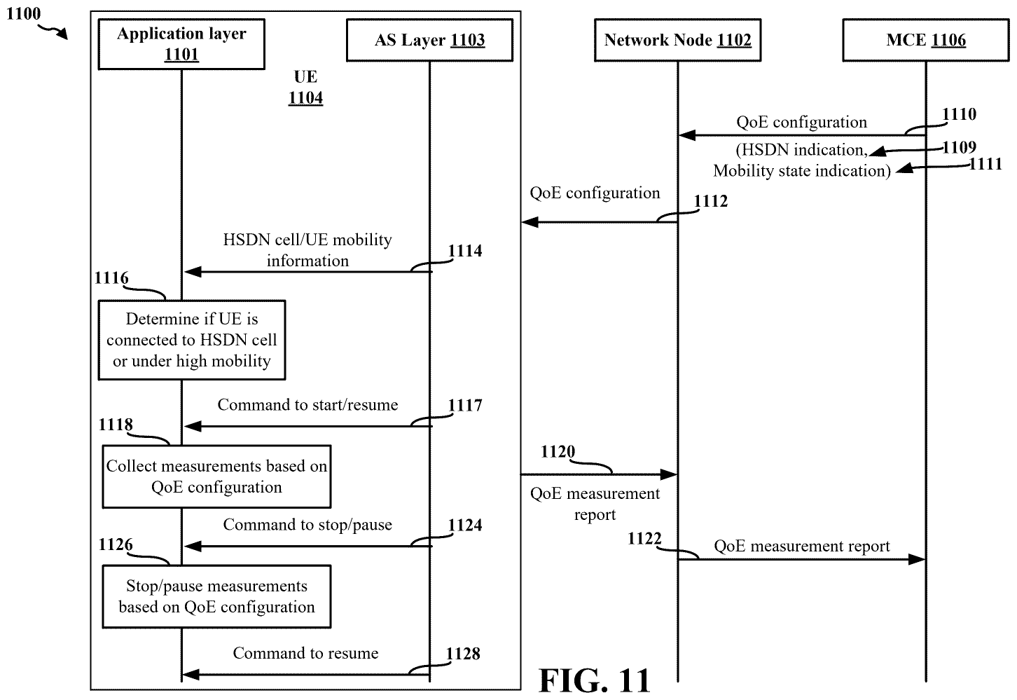

FIG. 11 illustrates an example communication flow 1100 in which a UE 1104 may determine whether to collect and/or report QoE information. In some examples, the network may provide a QoE configuration to the UE irrespective of whether the UE is camped on an HSDN cell or a non-HSDN cell, and irrespective of whether the UE is under high mobility or low mobility, such as the first scenario 510, the second scenario 512, the third scenario 514, and/or the fourth scenario 516 of FIG. 5. FIG. 11 illustrates that an MCE 1106 may provide a QoE configuration 1110 and the network node 1102 may obtain (e.g., receive) the QoE configuration 1110. The network node 1102 may correspond to a RAN or a component of a RAN. The network node 1102 may correspond to a base station, such as the base station 102 or the base station 310, or a component of a base station such as the CU 110, DU 130, or RU 140. The QoE configuration 1110 may include an HSDN indication 1109 and/or mobility state indication 1111, such as described in connection with FIGS. 8 and 9. The network node 1102 may provide a QoE configuration to the UE 1104, e.g., without determining whether the UE is camped on an HSDN or whether the UE is in a high mobility state, as was done in FIGS. 8 and 9. For example, the network node 1102 may output (e.g., transmit or communicate) a QoE configuration 1112 that is received by the UE 1104. However, the QoE configuration 1112 may configure the UE 1104 to collect measurements while the UE 1104 is connected to an HSDN cell or under high mobility. The UE 1104 may be configured to provide the QoE measurement reports while connected to an HSDN cell. The UE 1104 may be configured to provide the QoE measurement reports while connected to a non-HSDN cell. Thus, the QoE configuration may be provided to a UE irrespective of whether the UE is camped on an HSDN cell or a non-HSDN cell and/or whether the UE is in a high mobility condition or low mobility condition.

FIG. 11 illustrates an example in which the QoE measurement collection according to the QoE configuration 1112 may be performed on HSDN cells and not on non-HSDN cells.

In some aspects, the UE access stratum (AS) layer (e.g., an AS layer 1103) forwards the HSDN cell information and the UE mobility state, at 1114, to an application layer 1101 of the UE. The application layer 1101 performs the QoE measurement collection only on HSDN cells and/or during a high mobility state of the UE 1104. As an example, at 1116, the application layer 1101 may determine that the UE 1104 is connected to an HSDN and/or is in a high mobility state. The application layer 1101 may then collect the QoE measurements, as shown at 1118.

In some aspects, the AS layer 1103 may send commands to the application layer 1101 to start/resume or stop/pause QoE collection. The commands may be ATtention (AT) commands sent from the AS layer 1103 to the application layer 1101. In this example, the AS layer 1103 may determine whether the UE 1104 is connected to an HSDN cell and/or is in a high mobility state and may provide commands to the application layer 1101. As an example, the AS layer 1103 may send a command 1117 indicating for the application layer 1101 to start collecting the QoE measurements, at 1118, based on the AS layer 1103 determining that the UE 1104 is connected to an HSDN cell and/or is in a high mobility state. The AS layer 1103 may send a command 1124 indicating for the network node 1102 to pause QoE collections, for example, in response to the UE 1104 entering a non-HSDN cell or changing to a lower mobility state. The AS layer 1103 may send a command 1128 to resume the QoE collection of QoE information in response to the UE 1104 entering another HSDN cell or changing to a high mobility state. The application layer 1101 may collect the QoE measurements, such as shown at 1118, and pause or stop the QoE measurements, as shown at 1126, in response to the commands from the AS layer 1103. FIG. 11 illustrates that the UE 1104 may report the QoE measurements, e.g., via a QoE measurement report 1120, to the network node 1102. The network node 1102 may provide a QoE measurement report 1122 to the MCE 1106 based on the QoE measurement report 1120.

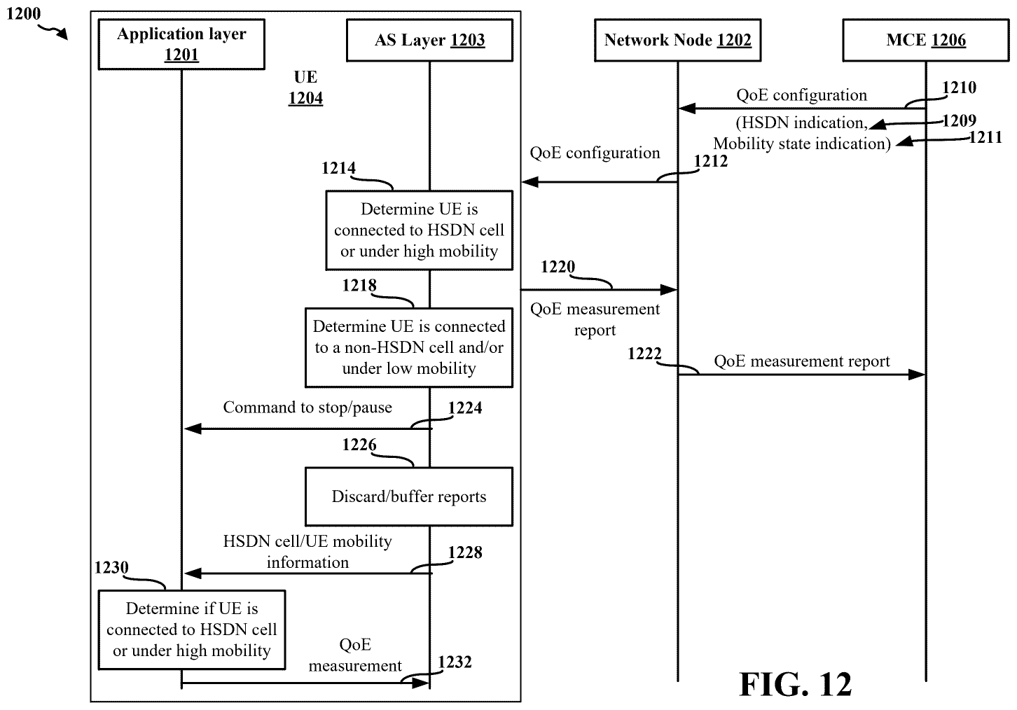

In some aspects, the UE may send the QoE report to a RAN from HSDN cells, e.g., only from an HSDN cell. Similarly, in some aspects, the UE may send the QoE report to a RAN from only non-HSDN cells, if that is a preference. FIG. 12 illustrates an example communication flow 1200 in which a UE 1204 may determine whether to report QoE information. In some aspects, the UE may also determine whether to collect the QoE measurements, such as described in connection with FIG. 11. In some examples, the network may provide a QoE configuration to the UE irrespective of whether the UE is camped on an HSDN cell or a non-HSDN cell, and irrespective of whether the UE is under high mobility or low mobility, such as the first scenario 510, the second scenario 512, the third scenario 514, and/or the fourth scenario 516 of FIG. 5. FIG. 12 illustrates that an MCE 1206 may provide a QoE configuration 1210 to the network node 1202. The network node 1202 may correspond to a RAN or a component of a RAN. The network node 1202 may correspond to a base station, such as the base station 102 or the base station 310, or a component of a base station such as the CU 110, DU 130, or RU 140. The QoE configuration 1210 may include an HSDN indication 1209 and/or mobility state indication 1211, such as described in connection with FIGS. 8 and 9. The network node 1202 may provide a QoE configuration 1212 to the UE 1204, e.g., without determining whether the UE is camped on an HSDN or whether the UE is in a high mobility state, as was done in FIGS. 8 and 9. However, the QoE configuration 1212 may configure the UE 1104 to report measurements while the UE 1204 is connected to an HSDN cell or under high mobility. The UE 1204 may be configured to provide the QoE measurement reports while connected to an HSDN cell. The UE 1204 may be configured to provide the QoE measurement reports while connected to a non-HSDN cell. Thus, the QoE configuration may be provided to a UE irrespective of whether the UE is camped on an HSDN cell or a non-HSDN cell and/or whether the UE is in a high mobility condition or low mobility condition, and the UE may filter QoE reports based on the HSDN cell or mobility state of the UE.

In some aspects, the AS layer 1203 may check whether the current cell is an HSDN cell, e.g., according to a SIB1 from the cell, and/or whether the UE is in a high mobility state and may send a QoE measurement report 1220 to the network node 1202 if the UE is camped on an HSDN cell and/or in a high mobility state, e.g., as determined at 1214.

If the UE camps on a non-HSDN cell, as shown at 1218, the AS layer 1103 may send a command 1224 to the application layer 1201 to pause QoE reporting from until the UE camps back on an HSDN cell and/or is in a high mobility state, discard (at 1226) the QoE reports received from the application layer 1201 until the UE camps back on an HSDN cell and/or is in a high mobility state, or buffer (at 1226) the QoE reports from the application layer 1201 in AS layer 1203 memory until the UE camps back on an HSDN cell and/or is in a high mobility state.

In some aspects, the AS layer 1203 may forward HSDN cell information and/or mobility state information to the application layer 1201, at 1216, e.g., based on the determination, at 1228. Then, at 1230, the application layer 1201 may determine whether the conditions for the QoE report are met. The application layer 1201 may report the QoE data, e.g., QoE measurements 1232, in response to the UE camping on an HSDN cell or being in a high mobility date, and may skip reporting if the UE is camped on a non-HSDN cell or is in a lower mobility state. The QoE measurement report 1220 provided by the UE may be based on the determination by the application layer, in some aspects. The network node 1202 may then provide the QoE measurement data to the MCE 1206, at 1222.

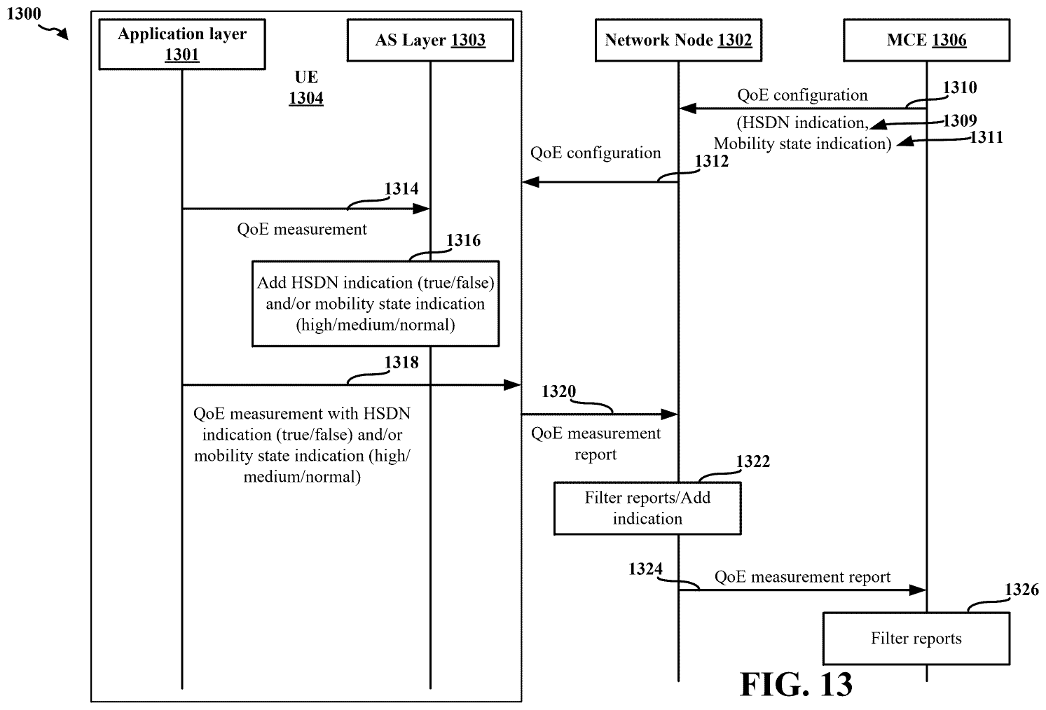

In some examples, the network may provide a QoE configuration to the UE regardless of whether the UE is camped on an HSDN cell or a non-HSDN cell, and regardless of whether the UE is under high mobility or low mobility, such as the first scenario 510, the second scenario 512, the third scenario 514, and/or the fourth scenario 516 of FIG. 5. Additionally, the UE may be configured to collect measurements and to provide QoE measurement reports regardless of the type of cell that the UE is camping on and the mobility of the UE. FIG. 13 illustrates example aspects in which the network may perform filtering of the QoE measurement reports based on indications included in the QoE measurement reports. FIG. 13 illustrates an example communication flow 1300 an MCE 1306 may provide a QoE configuration 1310 to the network node 1302. The network node 1302 may correspond to a RAN or a component of a RAN. The network node 1302 may correspond to a base station, such as the base station 102 or the base station 310, or a component of a base station such as the CU 110, DU 130, or RU 140. The QoE configuration 1310 may include an HSDN indication 1309 and/or mobility state indication 1311, such as described in connection with FIGS. 8 and 9. The network node 1302 may provide the QoE configuration to the UE 1304, at 1312, e.g., without determining whether the UE is camped on an HSDN or whether the UE is in a high mobility state, as was done in FIGS. 8 and 9. The UE 1304 may be configured to provide the QoE measurement reports along with information that enables the network to identify whether the QoE measurement is while the UE was connected to an HSDN cell and/or in a high mobility state.

For example, a QoE measurement report, e.g., a QoE measurement report 1320 or a QoE measurement report 1324 received at the network node 1302 or the MCE 1306, may include an HSDN indication indicating whether the UE 1204 is connected to an HSDN cell or a non-HSDN cell. The QoE measurement report, e.g., the QoE measurement report 1320 and/or the QoE measurement report 1324, may also include a mobility state indication indicating the mobility state of the UE 1304. In some examples, the UE 1304 may include the HSDN indication and/or the mobility state indication when generating the QoE measurement report. In some examples, the network may append the HSDN indication and/or the mobility state indication when forwarding the QoE report from the UE to the MCE. In such post-processing-based aspects, the MCE 1306 may filter the received QoE reports (e.g., the QoE measurement report 1324) based on the HSDN indication and the mobility state indication.

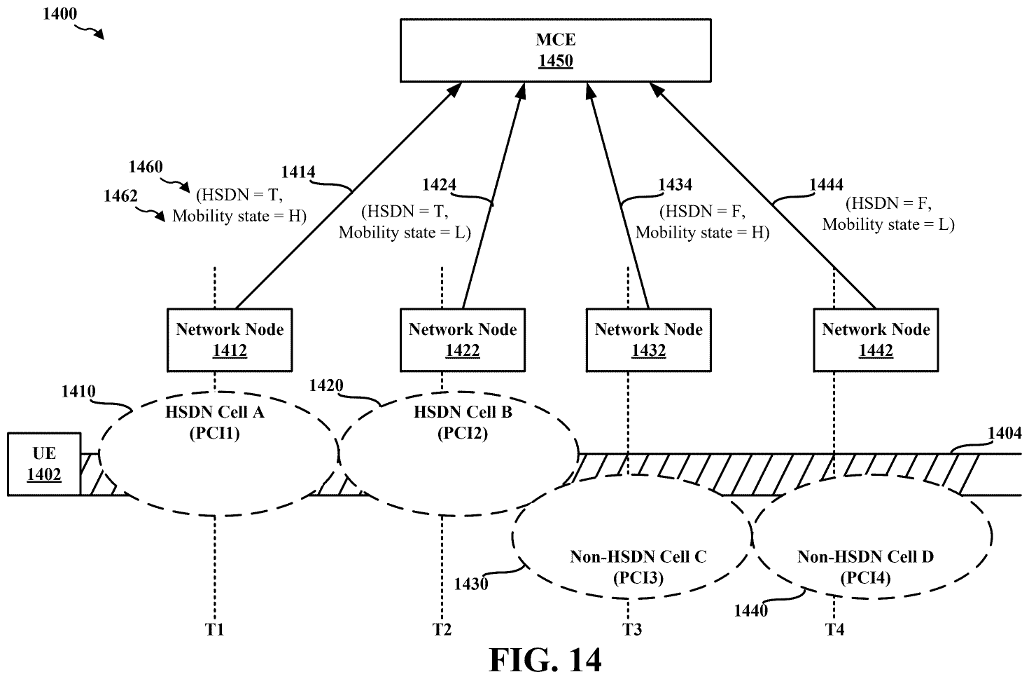

The QoE measurement collection and reporting at the UE 1304 may is done on both HSDN and non-HSDN cells and/or for different mobility conditions of the UE. The UE 1304 may send the QoE measurement report 1320 to the network node 1302 from both HSDN and non-HSDN cells, and the network node 1302 or the MCE 1306 may filter the QoE reports based on additional information. FIG. 14 illustrates example aspects of such additional information. In some aspects, the AS layer 1303 (e.g., RRC) at the UE 1304 may receive QoE measurements 1314 from the application layer 1301 and may add an HSDN indication and mobility state (high/medium/normal mobility), at 1316, along with the QoE measurement report 1320 to be transmitted over RRC. The network node 1302 filters the QoE reports at 1322, e.g., for “high mobility” and/or “HSDN indication=TRUE” and forwards the data for those QoE reports to the MCE 1306 (e.g., via the QoE measurement report 1324).

In some aspects, the application layer 1301 at the UE may add the HSDN indication and/or UE mobility state (high/medium/normal mobility) indication within the QoE report container, at 1318. The MCE 1306 may filter the desired QoE reports based on post-processing, as shown at 1326.

In some aspects, the network node 1302 may add the HSDN cell indication and/or UE mobility state indication to the QoE information, at 1322, before sending the QoE report data to the MCE, e.g., via the QoE measurement report 1324.

The UE may report its “mobility state” to the network node 1302 via self-organizing network (SON)/minimization of drive test (MDT) reports which may be forwarded to a trace collection entity (TCE) along with timestamp information. The UE may also report the QoE to the MCE 1306 along with timestamp information. In post processing, the network can filter the QoE report using the mobility state and time stamp information reported in connection with other information, such as the SON/MDT, to filter “high speed” QoE reports based on TCE-MCE interactions.

In a post-processing based solution, the QoE measurement report received at an MCE may be configured, e.g., via the QoE configuration, to include an HSDN indicator that indicates whether the UE is connected to an HSDN cell or a non-HSDN cell. The HSDN indicator may be 1-bit indicator in which a first value indicates that the UE is connected to an HSDN cell and a second value indicates that the UE is connected to a non-HSDN cell. In some examples, the QoE measurement report may additionally, or alternatively, be configured to include a mobility state indicator that indicates a mobility state of the UE.

FIG. 14 illustrates an example environment 1400 to facilitate providing QoE reports in high mobility scenarios as a UE 1402 moves between different mobility scenarios, as presented herein. In the example of FIG. 14, the UE 1402 may be an HSDN-capable UE, such as the HSDN-capable UE 502 of FIG. 5. The UE 1402 may also be located on a vehicle capable of high mobility, such as an HST or a vehicle traveling on a highway.

Aspects of the environment 1400 may be similar to the example environment 700 of FIG. 7. For example, the UE 1402 may travel on a path 1404. For example, at time T1, the UE 1402 may be connected to a first network node 1412 that provides coverage to a first cell 1410 (“PCI1”), at time T2, the UE 1402 may be connected to a second network node 1422 that provides coverage to a second cell 1420 (“PCI2”), at time T3, the UE 1402 may be connected to a third network node 1432 that provides coverage to a third cell 1430 (“PCI3”), and at time T4, the UE 1402 may be connected to a fourth network node 1442 that provides coverage to a fourth cell 1440 (“PCI4”). Similar to the example of FIG. 7, the first cell 1410 and the second cell 1420 are HSDN cells, and the third cell 1430 and the fourth cell 1440 are non-HSDN cells.

In the example of FIG. 14, the UE 1402 may satisfy criteria associated with the first scenario 510 of FIG. 5 when the UE 1402 is connected to the first network node 1412, may satisfy criteria associated with the second scenario 512 of FIG. 5 when the UE 1402 is connected to the second network node 1422, may satisfy criteria associated with the third scenario 514 of FIG. 5 when the UE 1402 is connected to the third network node 1432, and may satisfy criteria associated with the fourth scenario 516 when the UE 1402 is connected to the fourth network node 1442.

As shown in FIG. 14, an MCE 1450 may receive QoE measurement reports generated by the UE 1402 as the UE 1402 moves across the path 1404. For example, the MCE 1450 may receive a first QoE measurement report 1414 associated with the first cell 1410, may receive a second QoE measurement report 1424 associated with the second cell 1420, may receive a third QoE measurement report 1434 associated with the third cell 1430, and may receive a fourth QoE measurement report 1444 associated with the fourth cell 1440. The QoE measurement reports may include an HSDN indicator 1460 and/or a mobility state indicator 1462 that provides cell and/or mobility information of the UE 1402 to the MCE 1450. For example, with respect to the first QoE measurement report 1414, the value of the HSDN indicator 1460 and the mobility state indicator 1462 indicate that the UE 1402 in connected to an HSDN cell (e.g., “HSDN indictor=True”) and that the UE 1402 is under high mobility (e.g., “Mobility state=High). In a similar manner, the second QoE measurement report 1424 indicates that the UE 1402 is connected to an HSDN cell (e.g., “HSDN indictor=True”) and that the UE 1402 is under low mobility (e.g., “Mobility state=Low”). The third QoE measurement report 1434 indicates that the UE 1402 is connected to a non-HSDN cell (e.g., “HSDN indictor=False”) and that the UE 1402 is under high mobility (e.g., “Mobility state=High”). The fourth QoE measurement report 1444 indicates that the UE 1402 is connected to a non-HSDN cell (e.g., “HSDN indictor=False”) and that the UE 1402 is under low mobility (e.g., “Mobility state=Low”).

Although the mobility state of the UE 1402 in the example of FIG. 14 is indicated as either “High” or “Low,” in other examples, the mobility state indicator 1462 may indicate additional or alternate mobility states. For example, the mobility state indicator 1462 may indicate a high-mobility state, a medium-mobility state, or a normal-mobility state.

The HSDN indicator 1460 and/or the mobility state indicator 1462 may be provided by the network and/or the UE. For example, the UE may send the report to the network, and the network sends the report to the MCE.

In some aspects, the AS/RRC layer of the UE may add the HSDN indicator 1460 and the mobility state indicator 1462 along with the QoE report. The UE may provide the QoE report, the HSDN indicator 1460 and the mobility state indicator 1462 via RRC signaling to the network node. The Network may then filter the QoE reports for high mobility and/or HSDN cells and forward those QoE reports to the MCE.

In some aspects, the UE application layer may add the HSDN indicator 1460 and/or the mobility state indicator 1462. In this example, the UE may provide the indications in a QoE report container. The network may not know the values of the indicators, and may simply forward the container to the MCE. The MCE may then perform filtering for the desired QoE reports.

In some aspects, the network node may add the HSDN indicator and the mobility state indicator. The indications in the QoE measurement reports received by the MCE may be provided by the network and/or the UE. When the UE provides the indications, the UE may provide the indications from the AS layer or the application layer of the UE.

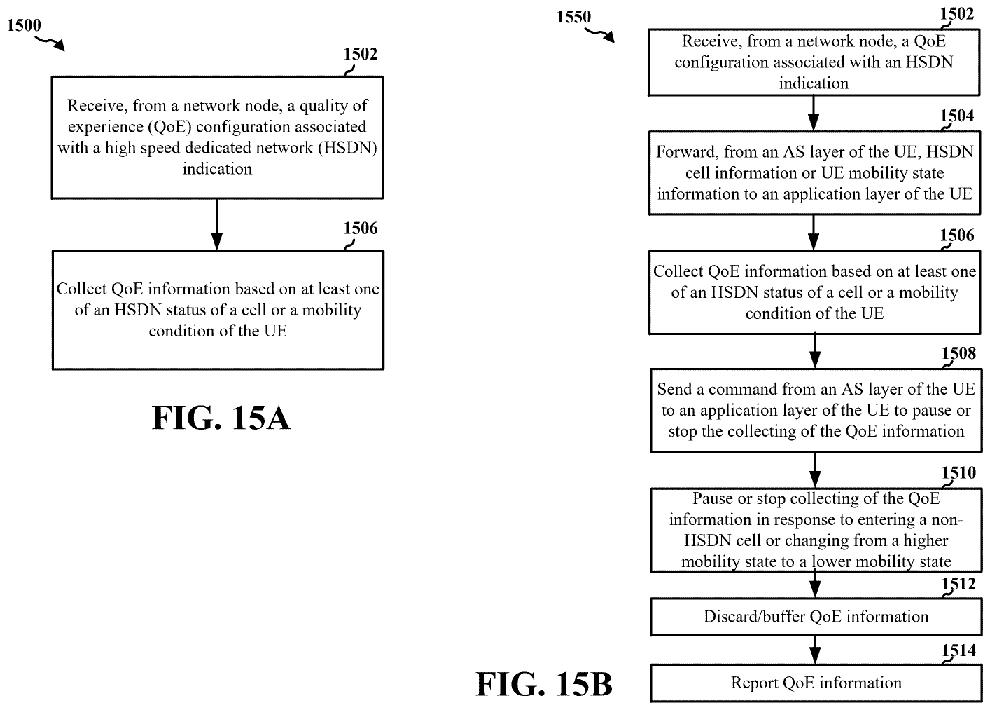

FIG. 15A is a flowchart 1500 of a method of wireless communication. The method may be performed by a UE (e.g., the UE 104, the UE 350; the apparatus 1604). The method may enable the UE to make decisions about whether to report QoE information based on a type of cell and/or a mobility state of the UE, which improves the QoE information provided to the network and increases the efficient use of wireless resources to send the QoE information. The method may include aspects described in connection with FIGS. 11 and/or 12.

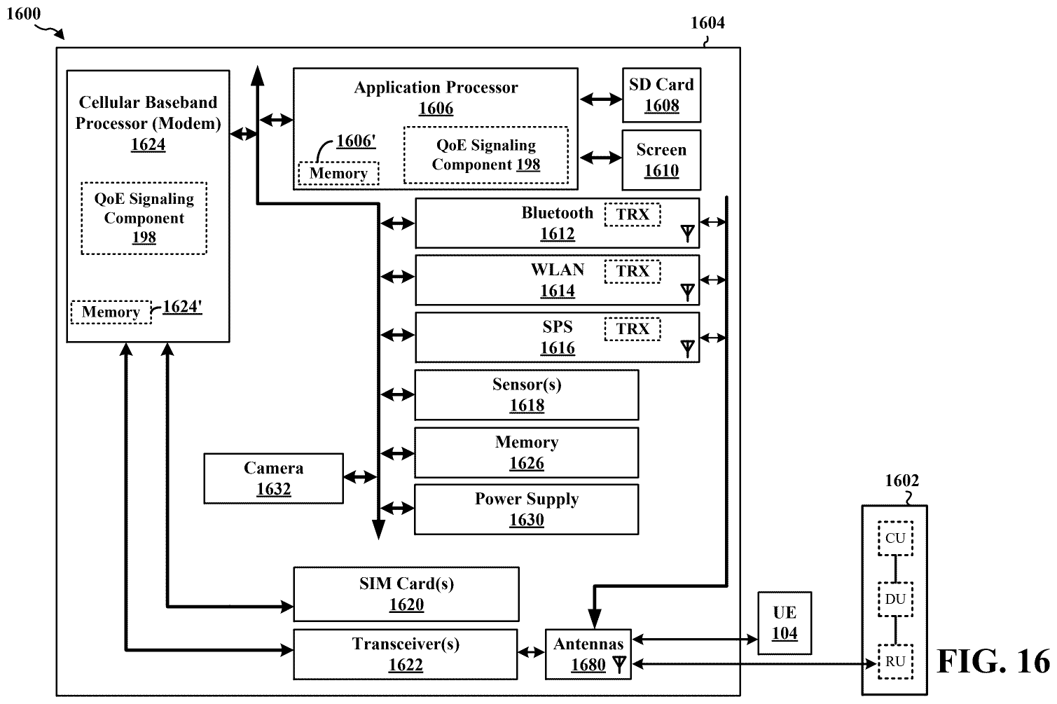

At 1502, the UE receives, from a network node, a QoE configuration associated with an HSDN indication. The receipt may be performed, e.g., by any of the QoE signaling component 198, a cellular RF transceiver 1622, and/or one or more antennas 1680 of the apparatus 1604 in FIG. 16. In some aspects, the UE may receive the QoE configuration irrespective of whether the UE is camped on an HSDN cell or a non-HSDN cell. In some aspects the UE may receive the QoE configuration irrespective of a mobility state of the UE (e.g., whether the UE is in a higher mobility state or a lower mobility state).

At 1506, the UE collects QoE information based on at least one of an HSDN status of a cell or a mobility condition of the UE. In some aspects, the UE may collect the QoE information for an HSDN cell and skips collecting the QoE information for a non-HSDN cell. In some aspects, the UE may collect the QoE information for at least one of an HSDN cell and a non-HSDN cell based on a high mobility condition of the UE. The collection may be performed, e.g., by the QoE signaling component 198 of the apparatus 1604 in FIG. 16. The UE may report the collected QoE information to the network.

FIG. 15B is a flowchart 1550 of a method of wireless communication. The method may be performed by a UE (e.g., the UE 104, the UE 350; the apparatus 1604). The method may enable the UE to make decisions about whether to report QoE information based on a type of cell and/or a mobility state of the UE, which improves the QoE information provided to the network and increases the efficient use of wireless resources to send the QoE information. The method may include aspects described in connection with FIGS. 11 and/or 12.

At 1502, the UE receives, from a network node, a QoE configuration associated with an HSDN indication. The receipt may be performed, e.g., by any of the QoE signaling component 198, the cellular RF transceiver 1622, and/or one or more antennas 1680 of the apparatus 1604 in FIG. 16. In some aspects, the UE may receive the QoE configuration irrespective of whether the UE is camped on an HSDN cell or a non-HSDN cell. In some aspects the UE may receive the QoE configuration irrespective of a mobility state of the UE (e.g., whether the UE is in a higher mobility state or a lower mobility state).

At 1506, the UE collects QoE information based on at least one of an HSDN status of a cell or a mobility condition of the UE. In some aspects, the UE may collect the QoE information for an HSDN cell and skips collecting the QoE information for a non-HSDN cell. In some aspects, the UE may collect the QoE information for at least one of an HSDN cell and a non-HSDN cell based on a high mobility condition of the UE. The collection may be performed, e.g., by the QoE signaling component 198 of the apparatus 1604 in FIG. 16. The UE may report the collected QoE information to the network.

As illustrated at 1504, in some aspects, the UE may forward, from an AS layer of the UE, HSDN cell information or UE mobility state information to an application layer of the UE. The forwarding may be performed, e.g., by the QoE signaling component 198 of the apparatus 1604 in FIG. 16.

As illustrated at 1510, the UE may pause or stop collecting of the QoE information in response to entering a non-HSDN cell or changing from a higher mobility state to a lower mobility state. The pausing or stopping may be performed, e.g., by the QoE signaling component 198 of the apparatus 1604 in FIG. 16.

As an example, illustrated at 1508, the UE may send a command from an AS layer of the UE to an application layer of the UE to pause or stop the collecting of the QoE information. The command may be sent, e.g., by the QoE signaling component 198 of the apparatus 1604 in FIG. 16.

As illustrated at 1512, the UE may discard the QoE information received from an application layer until the UE camps on a second HSDN cell. In other aspects, as also illustrated at 1512, the UE may buffer the QoE information from the application layer until the UE is camping on the second HSDN cell. The discarding or buffering may be performed, e.g., by the QoE signaling component 198 of the apparatus 1604 in FIG. 16.

The UE may report the collected QoE information, e.g., as illustrated at 1514. In some aspects, the UE may report the QoE information to an HSDN cell and skip reporting of the QoE information to a non-HSDN cell. In some aspects, the UE may report the QoE information to a non-HSDN cell. As an example, the UE may report the QoE information to a non-HSDN cell and not to HSDN cells. In some aspects, the UE may report the QoE information based on the QoE configuration and including an indication for at least one of an association with an HSDN cell or a high mobility condition of the UE. The reporting may be performed, e.g., by the QoE signaling component 198 of the apparatus 1604 in FIG. 16.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers (e.g., a cellular RF transceiver 1622). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize one or more antennas 1680 for communication. The cellular baseband processor 1624 communicates through transceiver(s) (e.g., the cellular RF transceiver 1622) via one or more antennas 1680 with the UE 104 and/or with an RU associated with a network entity 1602. The cellular baseband processor 1624 and the application processor 1606 may each include a computer-readable medium/memory, such as the on-chip memory 1624′, and the on-chip memory 1606′, respectively. The additional memory modules 1626 may also be considered a computer-readable medium/memory. Each computer-readable medium/memory (e.g., the on-chip memory 1624′, the on-chip memory 1606′, and/or the additional memory modules 1626) may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see the UE 350 of FIG. 3) and include the additional modules of the apparatus 1604.

As discussed supra, the QoE signaling component 198 is configured to receive, from a network node, a QoE configuration associated with an HSDN indication and UE collect QoE information based on at least one of an HSDN status of a cell or a mobility condition of the UE. In some aspects, the QoE signaling component 198 may be further configured to forward, from an AS layer of the UE, HSDN cell information or

UE mobility state information to an application layer of the UE; pause or stop collecting of the QoE information in response to entering a non-HSDN cell or changing from a higher mobility state to a lower mobility state; send a command from an AS layer of the UE to an application layer of the UE to pause or stop the collecting of the QoE information; discard the QoE information received from an application layer until the UE camps on a second HSDN cell; buffer the QoE information from the application layer until the UE is camping on the second HSDN cell; or report the collected QoE information, e.g., as described in connection with FIG. 15B. The QoE signaling component 198 may be within the cellular baseband processor 1624, the application processor 1606, or both the cellular baseband processor 1624 and the application processor 1606. The QoE signaling component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for receiving, from a network node, a QoE configuration associated with an HSDN indication and means for collecting QoE information based on at least one of an HSDN status of a cell or a mobility condition of the UE. The apparatus may further include means for forwarding, from an AS layer of the UE, HSDN cell information or UE mobility state information to an application layer of the UE; means for pausing or stopping collecting of the QoE information in response to entering a non-HSDN cell or changing from a higher mobility state to a lower mobility state; means for sending a command from an AS layer of the UE to an application layer of the UE to pause or stop the collecting of the QoE information; means for discarding the QoE information received from an application layer until the UE camps on a second HSDN cell; means for buffering the QoE information from the application layer until the UE is camping on the second HSDN cell; or means for reporting the collected QoE information. The means may be the QoE signaling component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

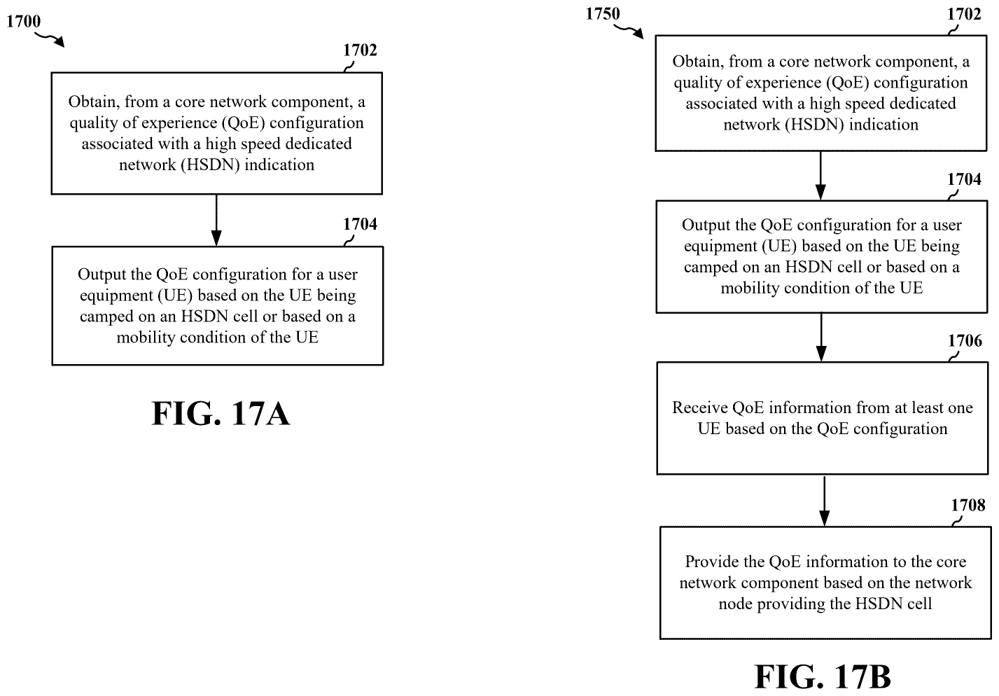

FIG. 17A is a flowchart 1700 of a method of wireless communication. The method may be performed by a network entity or network node (e.g., a base station or a component of a base station, such as the base station 102, the base station 310; the CU 110, the DU 130, the RU 140; the network entity 1602). The method may enable the network node to make decisions about whether to configure a UE to collected and/or report QoE information based on a type of cell and/or a mobility state of the UE, which improves the QoE information provided to the network and increases the efficient use of wireless resources to send the QoE configuration and/or to receive the QoE information. The method may include aspects described in connection with FIGS. 8 and/or 9.

At 1702, the network node obtains, from a core network component, a QoE configuration associated with an HSDN indication. As an example, the network node may receive the QoE configuration associated with the HSDN from the core network component. In some aspects, the network node may be a RAN that receives the QoE configuration from an MCE via an AMF. In other aspects, the network node may be a RAN that receives the QoE configuration rom the MCE directly. The obtaining may be performed, e.g., by the QoE configuration component 199.

At 1704, the network node outputs (e.g., transmits or communicates) the QoE configuration for a UE based on the UE being camped on an HSDN cell or based on a mobility condition of the UE. In some aspects, the QoE configuration may be a configuration for a single UE, and the network node may output the QoE configuration to the UE based on the UE being camped on the HSDN cell. As an example, the network node may transmit the QoE configuration to the UE. In some aspects, the QoE configuration may be a configuration for a single UE, and the network node may output the QoE configuration to the UE based on the UE meeting a high mobility condition. In some aspects, the QoE configuration may be a configuration for multiple UEs, and the network node may output the QoE configuration to each UE that is camped on the HSDN cell. In some aspects, the QoE configuration may be a configuration for multiple UEs, and the network node may output the QoE configuration to each UE meeting a high mobility condition. In some aspects, the network node may output the QoE configuration to the UE further based on the network node providing the HSDN cell. The output may be performed, e.g., by the QoE configuration component 199.

FIG. 17B is a flowchart 1750 of a method of wireless communication. The method may be performed by a network entity or network node (e.g., a base station or a component of a base station, such as the base station 102, the base station 310; the CU 110, the DU 130, the RU 140; the network entity 1602). The method may enable the network node to make decisions about whether to configure a UE to collected and/or report QoE information based on a type of cell and/or a mobility state of the UE, which improves the QoE information provided to the network and increases the efficient use of wireless resources to send the QoE configuration and/or to receive the QoE information. The method may include aspects described in connection with FIGS. 8 and/or 9.

At 1702, the network node obtains, from a core network component, a QoE configuration associated with an HSDN indication. As an example, the network node may receive the QoE configuration associated with the HSDN from the core network component. In some aspects, the network node may be a RAN that receives the QoE configuration from an MCE via an AMF. In other aspects, the network node may be a RAN that receives the QoE configuration rom the MCE directly. The obtaining may be performed, e.g., by the QoE configuration component 199.

At 1704, the network node outputs the QoE configuration for a UE based on the UE being camped on an HSDN cell or based on a mobility condition of the UE. In some aspects, the QoE configuration may be a configuration for a single UE, and the network node may output the QoE configuration to the UE based on the UE being camped on the HSDN cell. As an example, the network node may transmit the QoE configuration to the UE. In some aspects, the QoE configuration may be a configuration for a single UE, and the network node may output the QoE configuration to the UE based on the UE meeting a high mobility condition. In some aspects, the QoE configuration may be a configuration for multiple UEs, and the network node may output the QoE configuration to each UE that is camped on the HSDN cell. In some aspects, the QoE configuration may be a configuration for multiple UEs, and the network node may output the QoE configuration to each UE meeting a high mobility condition. In some aspects, the network node may output the QoE configuration to the UE further based on the network node providing the HSDN cell. The output may be performed, e.g., by the QoE configuration component 199.

As illustrated at 1706, the network node may receive QoE information from at least one UE based on the QoE configuration. If the QoE configuration was for a single UE, the network node may receive the QoE information from the single UE. If the QoE configuration was for multiple UEs, the network node may receive the QoE information from the multiple UEs. The reception may be performed, e.g., by the QoE configuration component 199. The QoE measurement collection may be done only on HSDN cells, in some aspects. In some aspects, the QoE report may be received only at HSDN cells or when the UE is in a particular mobility condition.

As illustrated at 1708, the network node may provide the QoE information to the core network component based on the network node providing the HSDN cell. The QoE information may include information for the HSDN cell, e.g., and not for non-HSDN cells. The provision may be performed, e.g., by the QoE configuration component 199.

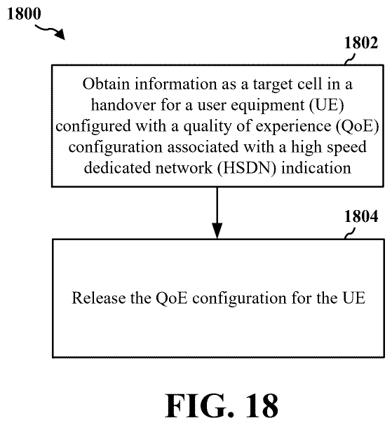

FIG. 18 is a flowchart 1800 of a method of wireless communication. The method may be performed by a network entity or network node (e.g., a base station or a component of a base station, such as the base station 102, the base station 310; the CU 110, the DU 130, the RU 140; the network entity 1602). The method may enable the network node to make decisions about whether to release a UE from collecting and/or report QoE information based on a type of cell and/or a mobility state of the UE, which improves the QoE information provided to the network and increases the efficient use of wireless resources to send the QoE configuration and/or to receive the QoE information. The method may include aspects described in connection with FIG. 10.

At 1802, the network node obtains information as a target cell in a handover for a UE configured with a QoE configuration associated with an HSDN indication. In some aspects, the information may be obtained as the target cell in the handover includes the HSDN indication, which is obtained in at least one of an Xn handover, an NG handover, or during an Xn UE context retrieval. The obtaining may be performed, e.g., by the QoE configuration component 199.

At 1804, the network node releases the QoE configuration for the UE. In some aspects, the network node may release the QoE configuration for the UE based on the target cell being outside an area associated with the QoE configuration. In some aspects, the network node may release the QoE configuration for the UE based on the target cell being a non-HSDN cell. In some aspects, the network node may release the QoE configuration for the UE based on the UE failing to meet a mobility condition.

In some aspects, the network node may release the QoE configuration for the UE based on the target cell having no ongoing sessions with the UE for the QoE configuration. The release may be performed, e.g., by the QoE configuration component 199.

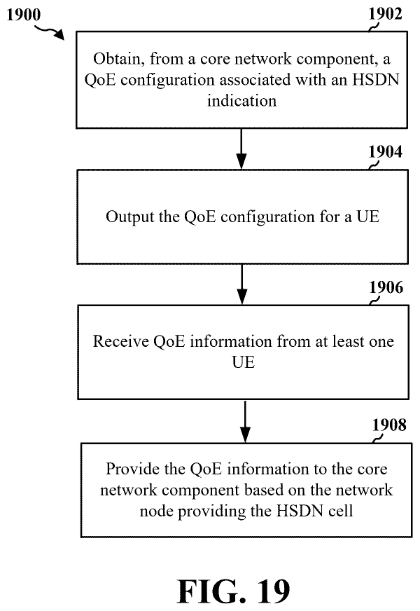

FIG. 19 is a flowchart 1900 of a method of wireless communication. The method may be performed by a network entity or network node (e.g., a base station or a component of a base station, such as the base station 102, the base station 310; the CU 110, the DU 130, the RU 140; the network entity 1602). The method may enable the network node to filter collected QoE information that is receives based on a type of cell and/or a mobility state of the UE, which improves the QoE information provided to the core network and increases the efficient use of wireless resources to send the QoE configuration and/or to receive the QoE information. The method may include aspects described in connection with FIGS. 13 and/or 14.

At 1902, the network node obtains, from a core network component, a QoE configuration associated with an HSDN indication. The obtaining may be performed, e.g., by the QoE configuration component 199. The QoE configuration may be for provision to UEs irrespective of whether a UE is camped on an HSDN cell and/or whether the UE is in a higher mobility state or a lower mobility state.

At 1904, the network node outputs the QoE configuration to at least one UE. The network node may output the QoE configuration to multiple UEs including one or more UEs that are being served by another cell and are in a lower mobility condition. The output may be performed, e.g., by the QoE configuration component 199.

At 1906, the network node receives QoE information from the at least one UE. In some aspects, the network node may receive, with the QoE information, the indication for at least one of the association with the HSDN cell or the high mobility condition of the at least one UE from an access stratum layer or an application layer of the at least one UE. The network node may receive the QoE information from UEs served by HSDN cells and non-HSDN cells and/or from UEs in a higher mobility state and a lower mobility state. The reception may be performed, e.g., by the QoE configuration component 199.

At 1908, the network node reports the QoE information to the core network component for each UE of the at least one UE that includes an indication for at least one of an association with an HSDN cell or a high mobility condition of the at least one UE. In some aspects, the network node may filter the QoE information to report only the information measured for HSDN cells or for UEs in a higher mobility state. The reporting may be performed, e.g., by the QoE configuration component 199.

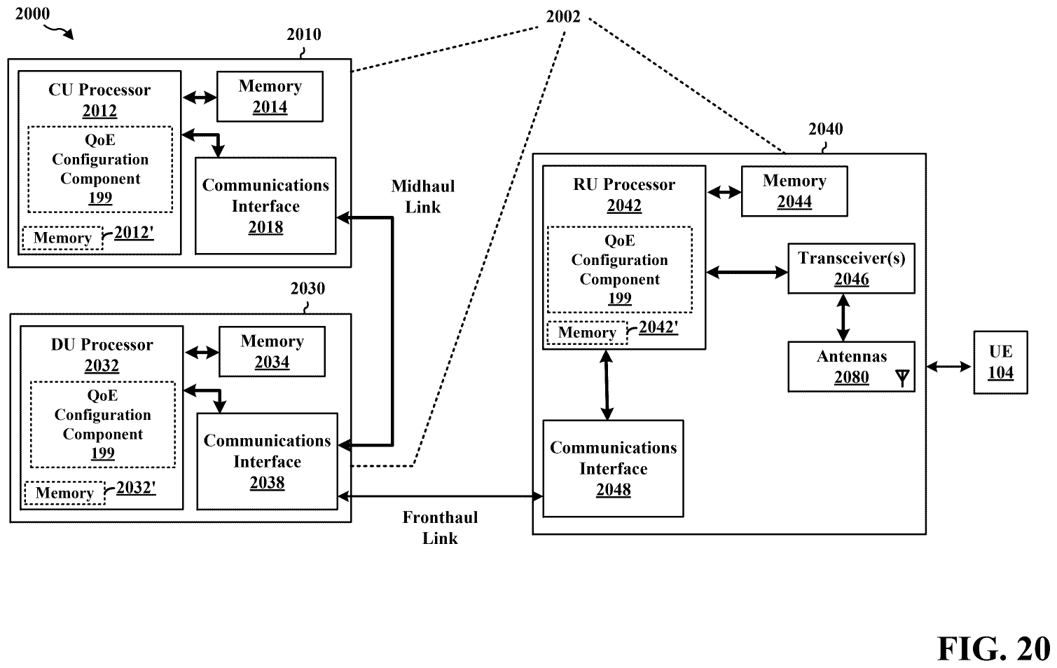

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the QoE configuration component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memories (e.g., the on-chip memory 2012′, the on-chip memory 2032′, and/or the on-chip memory 2042′) and/or the additional memory modules (e.g., the additional memory modules 2014, the additional memory modules 2034, and/or the additional memory modules 2044) may each be considered a computer-readable medium/memory. Each computer-readable medium/memory may be non-transitory. Each of the CU processor 2012, the DU processor 2032, the RU processor 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the QoE configuration component 199 in some aspects may be configured to obtain, from a core network component, a QoE configuration associated with an HSDN indication and output the QoE configuration for a UE based on the UE being camped on an HSDN cell or based on a mobility condition of the UE. In some aspects, the QoE configuration component 199 may be configured to receive only at HSDN cells or when the UE is in a particular mobility condition; and provide the QoE information to the core network component based on the network node providing the HSDN cell. In some aspects, the QoE configuration component 199 may be configured to obtain information as a target cell in a handover for a UE configured with a QoE configuration associated with an HSDN indication, and release the QoE configuration for the UE. In some aspects, the QoE configuration component 199 may be configured to obtain, from a core network component, a QoE configuration associated with an HSDN indication; output the QoE configuration to at least one UE; receive QoE information from the at least one UE; and report the QoE information to the core network component for each UE of the at least one UE that includes an indication for at least one of an association with an HSDN cell or a high mobility condition of the at least one UE. The QoE configuration component 199 may be within one or more processors of one or more of the CU 2010, DU 2030, and the RU 2040. The QoE configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 includes means for obtaining, from a core network component, a QoE configuration associated with an HSDN indication and means for outputting the QoE configuration for a UE based on the UE being camped on an HSDN cell or based on a mobility condition of the UE. The apparatus may further include means for receiving QoE information from at least one UE based on the QoE configuration; and means for providing the QoE information to the core network component based on the network node providing the HSDN cell. The apparatus may include means for obtaining information as a target cell in a handover for a UE configured with a QoE configuration associated with an HSDN indication, and releasing the QoE configuration for the UE. In some aspects, the apparatus may include means for obtaining, from a core network component, a QoE configuration associated with an HSDN indication; means for outputting the QoE configuration to at least one UE; means for receiving QoE information from the at least one UE; and means for reporting the QoE information to the core network component for each UE of the at least one UE that includes an indication for at least one of an association with an HSDN cell or a high mobility condition of the at least one UE. The means may be the QoE configuration component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a network node, comprising: obtaining, from a core network component, a QoE configuration associated with an HSDN indication; and outputting the QoE configuration for UE based on the UE being camped on an HSDN cell or based on a mobility condition of the UE.
Aspect 2 is the method of aspect 1, further including that the QoE configuration is for a configuration for a single UE, and wherein the network node outputs the QoE configuration to the UE based on the UE being camped on the HSDN cell.
Aspect 3 is the method of any of aspects 1 and 2, further including that the QoE configuration is for a configuration for a single UE, and wherein the network node outputs the QoE configuration to the UE based on the UE meeting a high mobility condition.
Aspect 4 is the method of aspect 1, further including that the QoE configuration is for a configuration for multiple UEs, and wherein the network node outputs the QoE configuration to each UE that is camped on the HSDN cell.
Aspect 5 is the method of any of aspects 1 and 4, further including that the QoE configuration is for a configuration for multiple UEs, and wherein the network node outputs the QoE configuration to each UE meeting a high mobility condition.
Aspect 6 is the method of any of aspects 1 to 5, further including that the network node outputs the QoE configuration to the UE further based on the network node providing the HSDN cell.
Aspect 7 is the method of any of aspects 1 to 6, further including: receiving QoE information from at least one UE based on the QoE configuration; and providing the QoE information to the core network component based on the network node providing the HSDN cell.
Aspect 8 is an apparatus for wireless communication at a network node including at least one processor coupled to a memory and configured to implement any of aspects 1 to 7.
In aspect 9, the apparatus of aspect 8 further includes at least one antenna coupled to the at least one processor.
In aspect 10, the apparatus of aspect 8 or 9 further includes a transceiver coupled to the at least one processor.
Aspect 11 is an apparatus for wireless communication including means for implementing any of aspects 1 to 7.
In aspect 12, the apparatus of aspect 11 further includes at least one antenna coupled to the means to perform the method of any of aspects 1 to 7.
In aspect 13, the apparatus of aspect 11 or 12 further includes a transceiver coupled to the means to perform the method of any of aspects 1 to 7.
Aspect 14 is a non-transitory computer-readable storage medium storing computer executable code, where the code, when executed, causes a processor to implement any of aspects 1 to 7.
Aspect 15 is a method of wireless communication at a network node, comprising: obtaining information as a target cell in a handover for a UE configured with a QoE configuration associated with an HSDN indication; and releasing the QoE configuration for the UE.
Aspect 16 is the method of aspect 15, further including: releasing the QoE configuration for the UE based on the target cell being outside an area associated with the QoE configuration.
Aspect 17 is the method of any of aspects 15 and 16, further including: releasing the QoE configuration for the UE based on the target cell being a non-HSDN cell.
Aspect 18 is the method of any of aspects 15 to 17, further including: releasing the QoE configuration for the UE based on the UE failing to meet a mobility condition.
Aspect 19 is the method of any of aspects 15 to 18, further including: releasing the QoE configuration for the UE based on the target cell having no ongoing sessions with the UE for the QoE configuration.
Aspect 20 is the method of any of aspects 15 to 19, further including that the information obtained as the target cell in the handover includes the HSDN indication, which is obtained in at least one of an Xn handover, an NG handover, or during an Xn UE context retrieval.
Aspect 21 is an apparatus for wireless communication at a network node including at least one processor coupled to a memory and configured to implement any of aspects 15 to 20.
In aspect 22, the apparatus of aspect 21 further includes at least one antenna coupled to the at least one processor.
In aspect 23, the apparatus of aspect 21 or 22 further includes a transceiver coupled to the at least one processor.
Aspect 24 is an apparatus for wireless communication including means for implementing any of aspects 15 to 20.
In aspect 25, the apparatus of aspect 24 further includes at least one antenna coupled to the means to perform the method of any of aspects 15 to 20.
In aspect 26, the apparatus of aspect 24 or 25 further includes a transceiver coupled to the means to perform the method of any of aspects 15 to 20.
Aspect 27 is a non-transitory computer-readable storage medium storing computer executable code, where the code, when executed, causes a processor to implement any of aspects 15 to 20.
Aspect 28 is a method of wireless communication at a UE, comprising: receiving, from a network node, a QoE configuration associated with an HSDN indication; and collecting QoE information based on at least one of an HSDN status of a cell or a mobility condition of the UE.
Aspect 29 is the method of aspect 28, further including: forwarding, from an AS layer of the UE, HSDN cell information or UE mobility state information to an application layer of the UE.
Aspect 30 is the method of any of aspects 28 and 29, further including: collecting the QoE information for an HSDN cell and skipping collecting the QoE information for a non-HSDN cell.
Aspect 31 is the method of any of aspects 28 and 29, further including: collecting the QoE information for at least one of an HSDN cell and a non-HSDN cell based on a high mobility condition of the UE.
Aspect 32 is the method of any of aspects 28 to 31, further including: pausing or stopping collecting of the QoE information in response to entering a non-HSDN cell or changing from a higher mobility state to a lower mobility state.
Aspect 33 is the method of any of aspects 28 to 32, further including: sending a command from an AS layer of the UE to an application layer of the UE to pause or stop the collecting of the QoE information.
Aspect 34 is the method of any of aspects 28 to 33, further including at least one of: discarding the QoE information received from an application layer until the UE camps on a second HSDN cell, or buffering the QoE information from the application layer until the UE is camping on the second HSDN cell.
Aspect 35 is the method of any of aspects 28 to 34, further including: reporting the QoE information to an HSDN cell and skipping reporting of the QoE information to a non-HSDN cell.
Aspect 36 is the method of any of aspects 28 to 34, further including: reporting the QoE information to a non-HSDN cell.
Aspect 37 is the method of any of aspects 28 to 36, further including: reporting the QoE information based on the QoE configuration and including an indication for at least one of an association with an HSDN cell or a high mobility condition of the UE.
Aspect 38 is an apparatus for wireless communication at a UE including at least one processor coupled to a memory and configured to implement any of aspects 28 to 37.
In aspect 39, the apparatus of aspect 38 further includes at least one antenna coupled to the at least one processor.
In aspect 40, the apparatus of aspect 38 or 39 further includes a transceiver coupled to the at least one processor.
Aspect 41 is an apparatus for wireless communication including means for implementing any of aspects 28 to 37.
In aspect 42, the apparatus of aspect 41 further includes at least one antenna coupled to the means to perform the method of any of aspects 28 to 37.
In aspect 43, the apparatus of aspect 41 or 42 further includes a transceiver coupled to the means to perform the method of any of aspects 28 to 37.
Aspect 44 is a non-transitory computer-readable storage medium storing computer executable code, where the code, when executed, causes a processor to implement any of aspects 28 to 37.
Aspect 45 is a method of wireless communication at a network node, comprising: obtaining, from a core network component, a QoE configuration associated with an HSDN indication; outputting the QoE configuration to at least one UE; receiving QoE information from the at least one UE; and reporting the QoE information to the core network component for each UE of the at least one UE that includes an indication for at least one of an association with an HSDN cell or a high mobility condition of the at least one UE.
Aspect 46 is the method of aspect 45, further including: receiving, with the QoE information, the indication for at least one of the association with the HSDN cell or the high mobility condition of the at least one UE from an access stratum layer or an application layer of the at least one UE.
Aspect 47 is the method of any of aspects 45 and 46, further including that the QoE configuration is output to multiple UEs including one or more UEs that are being served by another cell and are in a lower mobility condition.
Aspect 48 is an apparatus for wireless communication at a network node including at least one processor coupled to a memory and configured to implement any of aspects 45 to 47.
In aspect 49, the apparatus of aspect 48 further includes at least one antenna coupled to the at least one processor.
In aspect 50, the apparatus of aspect 48 or 49 further includes a transceiver coupled to the at least one processor.
Aspect 51 is an apparatus for wireless communication including means for implementing any of aspects 1 to 47.

In aspect 52, the apparatus of aspect 51 further includes at least one antenna coupled to the means to perform the method of any of aspects 45 to 47.

In aspect 53, the apparatus of aspect 51 or 52 further includes a transceiver coupled to the means to perform the method of any of aspects 45 to 47.

Aspect 54 is a non-transitory computer-readable storage medium storing computer executable code, where the code, when executed, causes a processor to implement any of aspects 45 to 47.

What is claimed is:

1. An apparatus for wireless communication at a network node, comprising:
a memory; and
at least one processor coupled to the memory and, based at least in part on information stored in the memory, the at least one processor is configured to:
obtain, from a core network component, a quality of experience (QoE) configuration associated with a high speed dedicated network (HSDN) indication; and
output the QoE configuration for a user equipment (UE) based on the UE being camped on an HSDN cell or based on a mobility condition of the UE.

2. The apparatus of claim 1, wherein the QoE configuration is for a configuration for a single UE, and wherein the at least one processor is configured to:
output the QoE configuration to the UE based on the UE being camped on the HSDN cell.

3. The apparatus of claim 1, wherein the QoE configuration is for a configuration for a single UE, and wherein the at least one processor is configured to:
output the QoE configuration to the UE based on the UE meeting a high mobility condition.

4. The apparatus of claim 1, wherein the QoE configuration is for a configuration for multiple UEs, and wherein the at least one processor is configured to:
output the QoE configuration to each UE that is camped on the HSDN cell.

5. The apparatus of claim 1, wherein the QoE configuration is for a configuration for multiple UEs, and wherein the at least one processor is configured to:
output the QoE configuration to each UE meeting a high mobility condition.

6. The apparatus of claim 1, wherein the at least one processor is further configured to:
output the QoE configuration to the UE further based on the network node providing the HSDN cell.

7. The apparatus of claim 1, wherein the at least one processor is further configured to:
receive QoE information from at least one UE based on the QoE configuration; and
provide the QoE information to the core network component based on the network node providing the HSDN cell.

8. The apparatus of claim 1, further comprising a transceiver coupled to the at least one processor.

9. An apparatus for wireless communication at a network node, comprising:
a memory; and
at least one processor coupled to the memory and, based at least in part on information stored in the memory, the at least one processor is configured to:
obtain information as a target cell in a handover for a user equipment (UE) configured with a quality of experience (QoE) configuration associated with a high speed dedicated network (HSDN) indication; and
release the QoE configuration for the UE.

10. The apparatus of claim 9, wherein the at least one processor is configured to:
release the QoE configuration for the UE based on the target cell being outside an area associated with the QoE configuration.

11. The apparatus of claim 9, wherein the at least one processor is configured to:
release the QoE configuration for the UE based on the target cell being a non-HSDN cell.

12. The apparatus of claim 9, wherein the at least one processor is configured to:
release the QoE configuration for the UE based on the UE failing to meet a mobility condition.

13. The apparatus of claim 9, wherein the at least one processor is configured to:
release the QoE configuration for the UE based on the target cell having no ongoing sessions with the UE for the QoE configuration.

14. The apparatus of claim 9, wherein the information obtained as the target cell in the handover includes the HSDN indication, which is obtained in at least one of an Xn handover, a next generation (NG) handover, or during an Xn UE context retrieval.

15. The apparatus of claim 9, further comprising a transceiver coupled to the at least one processor.

16. An apparatus for wireless communication at a user equipment (UE), comprising:
a memory; and
at least one processor coupled to the memory and, based at least in part on information stored in the memory, the at least one processor is configured to:
receive, from a network node, a quality of experience (QoE) configuration associated with a high speed dedicated network (HSDN) indication; and
collect QoE information based on at least one of an HSDN status of a cell or a mobility condition of the UE.

17. The apparatus of claim 16, wherein the at least one processor is further configured to:
forward, from an access stratum (AS) layer of the UE, HSDN cell information or UE mobility state information to an application layer of the UE.

18. The apparatus of claim 16, wherein the at least one processor is configured to:
collect the QoE information for an HSDN cell and skip collecting the QoE information for a non-HSDN cell.

19. The apparatus of claim 16, wherein the at least one processor is configured to:
collect the QoE information for at least one of an HSDN cell and a non-HSDN cell based on a high mobility condition of the UE.

20. The apparatus of claim 16, wherein the at least one processor is further configured to:
pause or stop collecting of the QoE information in response to entering a non-HSDN cell or changing from a higher mobility state to a lower mobility state.

21. The apparatus of claim 20, wherein the at least one processor is further configured to:
send a command from an access stratum (AS) layer of the UE to an application layer of the UE to pause or stop the collecting of the QoE information.

22. The apparatus of claim 20, wherein the at least one processor is further configured to at least one of:
discard the QoE information received from an application layer until the UE camps on a second HSDN cell, or
buffer the QoE information from the application layer until the UE is camping on the second HSDN cell.

23. The apparatus of claim 16, wherein the at least one processor is further configured to:
report the QoE information to an HSDN cell and skipping reporting of the QoE information to a non-HSDN cell.

24. The apparatus of claim 16, wherein the at least one processor is further configured to:
report the QoE information to a non-HSDN cell.

25. The apparatus of claim 16, wherein the at least one processor is further configured to:
report the QoE information based on the QoE configuration and include an indication for at least one of an association with an HSDN cell or a high mobility condition of the UE.

26. The apparatus of claim 16, further comprising a transceiver coupled to the at least one processor.

27. An apparatus for wireless communication at a network node, comprising:
a memory; and
at least one processor coupled to the memory and, based at least in part on information stored in the memory, the at least one processor is configured to:
obtain, from a core network component, a quality of experience (QoE) configuration associated with a high speed dedicated network (HSDN) indication;
output the QoE configuration to at least one user equipment (UE);
receive QoE information from the at least one UE; and
report the QoE information to the core network component for each UE of the at least one UE that includes an indication for at least one of an association with an HSDN cell or a high mobility condition of the at least one UE.

28. The apparatus of claim 27, wherein the at least one processor is further configured to:
receive, with the QoE information, the indication for at least one of the association with the HSDN cell or the high mobility condition of the at least one UE from an access stratum layer or an application layer of the at least one UE.

29. The apparatus of claim 27, wherein the at least one processor is configured to:
output the QoE configuration to multiple UEs including one or more UEs that are being served by another cell and are in a lower mobility condition.

30. The apparatus of claim 27, further comprising a transceiver coupled to the at least one processor.
